(19) United States
(12) Patent Application Publication
(10) Pub. No.: US 2014/0189576 A1
(43) Pub. Date: Jul. 3, 2014

(54) SYSTEM AND METHOD FOR VISUAL MATCHING OF APPLICATION SCREENSHOTS

(71) Applicant: Applitools LTD., Petach Tikva (IL)

(72) Inventor: Adam CARMI, Petach Tikva (IL)

(73) Assignee: Applitools LTD., Petach Tikva (IL)

(21) Appl. No.: 14/166,893

(22) Filed: Jan. 29, 2014

Related U.S. Application Data
(63) Continuation-in-part of application No. 13/607,848, filed on Sep. 10, 2012.
(60) Provisional application No. 61/757,770, filed on Jan. 29, 2013.

(51) Int. Cl. G06F 3/0481

(52) U.S. Cl. CPC G06F 3/0481
USPC 715/781

(57) ABSTRACT

A system and method for automatically matching images of screens. A system and method may include automatically matching images of screens. A first screenshot of a screen may be obtained, the first screenshot including a view port exposing a portion of a panel. A second screenshot of a screen may be obtained. A digital difference image may be generated and a match between the first and second screenshots may be determined based on the digital difference image.

### CROSS-REFERENCE TO RELATED APPLICATIONS

This application is a continuation-in-part application of U.S. patent application Ser. No. 13/607,848, filed Sep. 10, 2012, entitled “SYSTEM AND METHOD FOR MODEL BASED SESSION MANAGEMENT” and this application claims benefit of U.S. Provisional Patent Application No. 61/757,770, filed Jan. 29, 2013, the entire disclosures of both of which are incorporated herein by reference.

### BACKGROUND

Systems and methods for modeling applications are known. For example, manually selecting and storing images and other information to produce a model is known. Other methods for modeling an application include inspecting the code structure of an application and producing a model of the source code, e.g., in the form of a flow chart or class diagrams.

However, current systems and methods suffer from a number of drawbacks. For example, manually generating a model may be time and effort consuming. Other modeling methods are tightly coupled to the implementation of the application being modeled and/or require cooperation with a developer of the application. Accordingly, current systems and methods are unsuitable and are impractical when modeling applications that have large number of states and screens or when screens are added or removed when an application evolves.

Methods of comparing or otherwise related digital images are known, for example, comparing pixels data in images. In contrast to comparing data at pixel level, embodiments of the invention compare or relate images at region level as described herein. A method utilizing regions, diff-images and diff-regions as described herein has a number of advantages that are impossible to realize using known techniques. For example, using diff-images and diff-regions as described herein to relate images is far faster than pixel oriented processing.

Methods and systems known in the art typically determine a match between digital images based on differences such as an intensity or other value associated with pixels used for digitally representing digital images. Accordingly, known methods may be expensive with respect to time and resources. Furthermore, known methods may often determine a mismatch between two digital images that may seem similar or same to a human.

Known systems and methods may wrongly determine two different screenshots match (or are the same) based on determining the two screenshots both include similar (or same) images. Known systems and methods cannot determine that two different screenshots are related to the same screen or application even if they are significantly different pixel-wise (e.g., the two screenshots represent different screens).

### SUMMARY OF THE INVENTION

Embodiments of the invention may include a system and method for automatically identifying a region of interest in an image of a screen produced by an application. An embodiment of a method may include identifying a set of elements in the image. Elements may be specific items displayed (partially or entirely, hidden or partially hidden) on a screen, monitor or display, for example displayed using pixels. For example, a set of elements may be a set of graphical user interface (GUI) elements, items or objects, e.g., images, buttons, text boxes, image boxes, icons, bitmaps, etc. The set of elements may be identified or detected in an image of a display screen. Other screen elements may be used. For example, a set of GUI elements may be identified in a screenshot of a display screen connected to computing device 400 described herein. An embodiment of a system or method may include determining a respective set of regions, the set of regions respectively containing the set of elements; combining at least a first and second regions included in the set of regions to produce a composite region; and associating the composite region with an element in the image of the screen.

An embodiment of a method may include combining a first and second regions based on at least one attribute, wherein the attribute may be one of: an adjacency, a dimension, a shape, a location, e.g., a location on a screen (e.g., represented by X, Y coordinates or other methods) of a first region with respect to a location of a second region, an inclusion, e.g., an inclusion of a first region in or within a second region, an overlapping, e.g., an overlapping of a first region and a second region, a background similarity between a first and second region and a texture similarity between regions. An embodiment of a method may include combining a first and a second region and may include removing at least one of the first and second regions. Identifying an element in image may include processing the image to produce a processed image, wherein the background of the image is distinguished from the foreground in the processed image; and identifying the element based on the processed image. Identifying an element in a processed image may include defining a sub-region in the processed image and identifying a foreground element in the sub-region.

In one embodiment, identifying an element in an image may include converting the image to a grayscale image and verifying the grayscale image has a dark background; removing elements from the grayscale image according to a threshold parameter to produce a processed image; determining a range of intensity values associated with a majority of pixels in the processed image; producing a binary image representing the determined intensity range; and identifying at least one element based on the binary image. Identifying an element may include converting the image to a grayscale image and verifying the grayscale image has a dark background; producing a second grayscale image to represent boundaries of elements in the grayscale image; producing a binary image based on the second grayscale image and based on a threshold pixel value; and identifying the at least one element based on the binary image. Producing a second grayscale image may include producing an eroded image by eroding elements in the grayscale image; and subtracting the eroded image from the grayscale image to produce the second grayscale image.

In one embodiment, a region (or a composite region) may be defined such that it corresponds to a GUI element presented on the screen. A region (or a composite region) may be used to determine a layout of a screen. An embodiment of a method may include producing, based on a binary image, a first processed image, the first processed image including consecutive lines along a selected axis; subtracting the first processed image from the binary image to produce a second processed image; expanding elements in the second processed image along the horizontal axis to produce an expanded image; merging the second processed image and the expanded image to produce a third image; and identifying an elements based on the third image.

In some embodiments, a computer-implemented method of automatically matching images of screens may include obtaining a first screenshot of a screen, the first screenshot including a view port exposing a portion of a panel; obtaining a second screenshot of a screen; selecting, based on an attribute of the view port, a region in the second screenshot; determining the second screenshot matches the first screenshot based on at least one of: relating content in the selected region to content in the panel, and relating a portion of the second screenshot excluded by the selected region to a respective portion of the first screenshot. An attribute of a view port may be any one of: a size of the view port, a location of the view port and a graphical element exposed by the view port. An embodiment of a method may include identifying a graphical element in the panel, wherein the element is exposed by the view port; and selecting the region in the second screenshot such that it includes the element.

An embodiment of a method may include generating a digital difference image representing at least one difference between one of: the second screenshot and the first screenshot and the second screenshot and the panel; defining a sub-region in the digital difference image, the sub-region excluding a border region in the digital difference image; and determining the second screenshot matches the first screenshot based on the sub-region. An embodiment of a method may include generating a digital difference image representing at least one difference between one of: the second screenshot and the first screenshot and the second screenshot and the panel; producing a processed digital difference image by removing elements smaller then a threshold size from the digital difference image; and determining the second screenshot matches the first screenshot based on the processed digital difference image.

An embodiment of a method may include generating a digital difference image representing at least one difference between one of: a second screenshot and a first screenshot and a second screenshot and a panel; determining a sub-region in the digital difference image matches identified respective regions in at least one of: the second screenshot and the first screenshot and the second screenshot and the panel, wherein the respective regions correspond to a graphical element included in the first screenshot and in the second screenshot; producing a processed digital difference image by removing a representation of a difference included in the sub-region; and determining the second screenshot matches the first screenshot based on the processed digital difference image.

An embodiment of a method may include generating a digital difference image representing at least one difference between one of: a second screenshot and a first screenshot and a second screenshot and a panel; determining a sub-region in the digital difference image is contained in a similar respective region in at least one of: the second screenshot and the first screenshot and the second screenshot and the panel; producing a processed digital difference image by removing a representation of a difference included in the sub-region; and determining the second screenshot matches the first screenshot based on the processed digital difference image. An embodiment of a method may include generating a digital difference image representing at least one difference between one of: the second screenshot and the first screenshot and the second screenshot and the panel; determining a sub-region in the digital difference image corresponds to at least one of: a region in the panel marked as floating and a region in the first screenshot marked as floating; determining a sub-region in the second screenshot that matches the sub-region in the digital difference image also matches one of the regions marked as floating; producing a processed digital difference image by removing a representation of a difference included in the sub-region in the digital difference image; and determining the second screenshot matches the first screenshot based on the processed digital difference image.

An embodiment of a method may include generating a digital difference image representing at least one difference between one of: a second screenshot and a first screenshot and the second screenshot and the panel; determining a sub-region in the digital difference image corresponds to at least one of: a region in the panel marked as floating and a region in the first screenshot marked as floating; determining a sub-region in the second screenshot that matches a sub-region in the digital difference image also matches one of the regions marked as floating.

An embodiment of a method may include producing a processed digital difference image by removing a representation of a difference included in one or more sub-regions in the digital difference image, the one or more sub-regions corresponding to at least one of: one of the regions marked as floating and to the sub-region in the second screenshot; and determining the second screenshot matches the first screenshot based on the processed digital difference image.

An embodiment of a method may include generating a digital difference image representing at least one difference between one of: a second screenshot and a first screenshot and the second screenshot and a panel; determining a sub-region in the digital difference image corresponds to at least one of: a region in the panel marked as a marker region and a region in the first screenshot marked as a marker region; and if no differences are included in the sub-region then determining the second screenshot matches the first screenshot. An embodiment of a method may include generating a digital difference image representing at least one difference between one of: the second screenshot and the first screenshot and the second screenshot and the panel; determining a sub-region in the digital difference image corresponds to at least one of: a region in the panel marked as a volatile region and a region in the first screenshot marked as a volatile region; producing a processed digital difference image by removing a representation of a difference included in the sub-region; and determining the second screenshot matches the first screenshot based on the processed digital difference image. An embodiment of a method may include determining the second screenshot matches the first screenshot if a set of representations of differences between the first screenshot and the second screenshot is confined by a confining region in the digital difference image, and the confining region is smaller than a threshold value.

An embodiment of a method may include generating a digital difference image representing at least one difference between one of: the second screenshot and the first screenshot and the second screenshot and the panel; and determining the second screenshot matches the first screenshot if the number of pixels representing a difference in the diff image is smaller than a threshold value.

An embodiment of a method may include generating a digital difference image representing at least one difference between one of: the second screenshot and the first screenshot and the second screenshot and the panel; determining the second screenshot matches the first screenshot if a sub-region in the digital difference image matches an identified region in only one of: the second screenshot and one of the first screenshot and the panel, one or more identified regions in another one of: the second screenshot and one of the first screenshot and the panel are included in an area defined by the sub-region, and the one or more identified regions are respectively present in the only one of: the second screenshot and one of the first screenshot and the panel.

An embodiment of a method may include generating a digital difference image representing at least one difference between one of: a second screenshot and a first screenshot and a second screenshot and a panel; determining a sub-region in the digital difference image corresponds to at least one of: a region in the panel marked as floating and a region in the first screenshot marked as floating; determining a sub-region in the second screenshot that matches a sub-region in the digital difference image also matches one of the regions marked as floating; producing a processed digital difference image by removing a representation of a difference included in one or more sub-regions in the digital difference image, the one or more sub-regions corresponding to at least one of: one of the regions marked as floating and to the sub-region in the second screenshot; and determining the second screenshot matches the first screenshot based on the processed digital difference image.

Images or screenshots captured herein may be those captured from a display or screen, for example displayed on a computer monitor or smartphone screen.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 shows a schematic diagram of exemplary screens and flows related to an application according to embodiments of the invention;

FIG. 2 schematically shows a representation of screens and related data in a model according to embodiments of the invention;

FIG. 3 is a high level schematic block diagram of a system according to embodiments of the invention;

FIG. 4 shows high level block diagram of an exemplary computing device according to embodiments of the present invention;

FIG. 5A is a flowchart diagram illustrating a method for automatically identifying a region of interest in an image according to some embodiments of the present invention;

FIG. 5B is a flowchart diagram illustrating a method for automatically identifying a region of interest in an image according to some embodiments of the present invention;

FIG. 6A shows a schematic diagram of exemplary screens according to embodiments of the invention;

FIG. 6B shows a schematic diagram of exemplary screens according to embodiments of the invention;

FIG. 7 schematically shows a representation of screens, regions and a panel according to embodiments of the invention;

FIG. 8 shows a schematic diagram of exemplary screens and regions according to embodiments of the invention;

FIG. 9 shows a schematic diagram of exemplary screens and regions according to embodiments of the invention;

FIG. 10 is a flowchart diagram illustrating a method according to some embodiments of the present invention; and

FIG. 11 is a flowchart diagram illustrating a method according to some embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

According to embodiments of the invention, a model of an application may be automatically generated and used in various ways as described herein. A model may include screenshots of screens produced by an application and additional, related information. The term “screen” (or “screens”) used herein may refer to any data displayed by an application, e.g., in a window covering part of a display screen or the entire display screen. For example, a screen may be an image of a calculator displayed on a display of a computing device by a calculator application.

As referred to herein, first and second screens may be any two screens selected from a plurality of screens displayed by an application. Accordingly, as referred to herein, a second screen is not necessarily presented immediately (or otherwise) after a first screen, and a first screen may not necessarily be the first screen presented by the calculator application, e.g., a first screen as referred to herein may be a screen displayed after a number of screens have been displayed, e.g., in a session or flow as described herein.

In some embodiments, transition information related to a transition (or flow) from a first screen to a second screen may be included in the model. It will be understood that when a first and second entities are referred to herein, these entities may be any two entities included in a set of a plurality of entities. For example, first and second screens as referred to herein may refer to the fifth and seventh screens displayed by an application when executed. Other information included in a model may be related to events, e.g., mouse clicks, keyboard keys pressed or other interactions with an application that may cause the application to replace or change screens being presented. Other information included in a model may be related to screen attributes, a context, a state of an application, a duration, an elapsed time or any other relevant aspect. Yet other information included in a model may be related to graphical user interface (GUI) elements, items or objects, e.g., in images, buttons, text boxes, etc. that may appear in a window or screen.

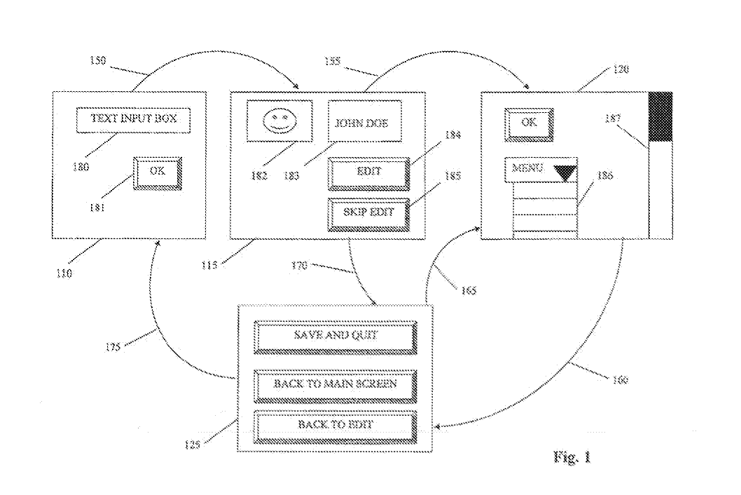

Reference is now made to FIG. 1 which shows a schematic diagram of exemplary screens and transitions or flows involving the screens. Although embodiments of the invention are not limited in this regard, the term “transition” as referred to herein should be expansively and broadly construed to include any sequential, successional, or other presentation of two screens. For example, a replacement, on a display screen of a computing device, of screen 110 by screen 115 may be referred to herein as a transition related to, involving, or including, screens screen 110 and screen 115 or, in short, a transition from 110 to screen 115. The term “flow” as referred to herein should be expansively and broadly construed to include any, possibly sequential, presentation of two or more screens and related events. For example, a presentation of screen 110, a click on button 181 and a subsequent presentation of screen 115 may be referred to herein as a flow related to, involving, or including, screens 110 and 115 and an event. In some embodiments or cases, a flow may not include events. For example, a flow may represent transitions from screens to other screens that may not be related to an interaction of a user or other events but, for example, may be caused by an application, e.g., based on time elapsed or other conditions.

Although embodiments of the invention are not limited in this regard, the term “session” used herein should be expansively and broadly construed to include any sequence of one or more interactions with an application and/or screens produced by the application. For example, a session may be, or may include, a presentation of screen 110, a click on button 181 and a presentation of screen 115. A session may be related to an interaction of a user with an application, accordingly, a session may be related to a set of events, e.g., a set of user actions, or interactions with screens, and the presentation of the related screens. Otherwise described, a session as referred to herein may include any information related to a dialog between a user and a computer or application or between a first and second applications. For example, any action performed by a user, and response or screen provided by an application, may be viewed as part of a session. A session may include one or more flows. Typically, a session may be related to an interaction with an application that may include performing one or more tasks, e.g., a registration of a user, a testing of a component and so on.

For example, the screens shown in FIG. 1 may be produced by an application that may enable viewing and/or editing a user profile. As shown, a first screen 110 may be produced by an application. In an embodiment and as shown, screen 110 may include a text input box element 180 that may be used for entering a name and a button 181 labeled “OK”. In an exemplary flow, a user may enter a name in text input box 180 and then press the button 181 element in order to proceed, e.g., cause a search for the user profile in a database and/or be provided with additional screens as described and shown.

As shown by arrow 150, a flow may include a transition from screen 110 to screen 115. For example, a transition may be a replacement (caused by the application) of screen 110 by screen 115. As shown, screen 115 may include an image 182 element (e.g., a picture of the relevant user), a label 183 element (e.g., the user name) a button 184 element labeled “EDIT” and a button 185 element labeled “SKIP EDIT”. As shown by arrows 155 and 170, a first flow or transition may include a transition from screen 115 to screen 120 (or a replacement of screen 115 by screen 120) and a second flow may include a transition from screen 115 to screen 125. For example, following a click on button 184 (“EDIT”) in screen 115, screen 120 may be produced, displayed or provided by the application, e.g., in order to enable modifying a user profile. Alternatively, pressing button 185 (“SKIP EDIT”) in screen 115 may cause a transition to screen 125. Similarly and as shown, a transition from screen 120 to screen 125 may be caused by the application, e.g., when a user is done editing a profile using the menu 186 element in screen 120 and further presses the “OK” button in screen 120. A screen may not fully display all items in the screen. For example and as shown, menu 186 may not be fully presented in a first screen but, using a scroll bar 187 element as shown, a screen fully presenting menu 186 may be provided.

As shown, the flow may include a transition (or returning) from a screen to a previous screen. For example and as shown by 165, by pressing the button labeled “BACK TO EDIT” shown in screen 125, a transition from screen 125 back to screen 120 may occur. Similarly, pressing the button labeled “BACK TO MAIN SCREEN” in screen 125 may cause the application to provide screen 110 subsequent to providing screen 125 as shown by 175. It will be understood that for the sake of clarity, the screens shown in FIG. 1 and items therein are simplified exemplary screens and items, and that any screens, including any items, may be applicable. For example, any GUI items, objects or elements may be included in screens discussed herein. For the sake of simplicity and clarity, FIG. 1 shows a limited number of screens, items in screens and flows, however, it will be understood that any number of flows and screens (including any number of items) may be applicable. In fact, embodiments of the invention may be particularly suitable for modeling applications that have large number of screens and possible flows.

According to embodiments of the invention, screenshots of screens produced by an application may be automatically captured and stored in a model. For example, a first and second screenshots of a respective first and second screens (e.g., screenshots of screens 120 and 125) produced by a first application may be automatically captured by a module, unit or second application, and may be stored in a model. A screenshot of a screen as referred to herein may include any information usable to render, display or present the screen on a display of a computing device. A screenshot of a screen as referred to herein may be, or may include, a bitmap, an array or set of values or parameters representing pixels, or any other information, data or parameter that may represent a screen produced by an application and/or usable to present or reproduce the screen.

Screenshots may be obtained from any applicable source using any system or method. For example, screenshots of screens produced by an application may be obtained from the application itself, from a video or expansion adapter, from an operating system or from a graphics card or board. Screenshots of screens produced by an application may be obtained using an application programming interface (API), e.g., graphics device interface (GDI), or directly from a device or component (e.g., a monitor, chip or card). It will be understood that embodiments of the invention are not limited by the method and/or system used to obtain screenshots of screens produced by an application. Any method of capturing screenshots may be used without departing from the scope of the present invention.

Capturing a screenshot of a screen may include determining a screen associated with the screenshot is stable, e.g., unchanged for a predefined period of time. Generally, as referred to herein, the terms “screenshot”, “image of a screen” and “image of a display screen” may all refer to the same entity. For example, an image of a screen, image of a display screen and screenshot may all be a digital representation (e.g., a bitmap or other pixel related information) of information presented on a display attached to a computing device as known in the art. Embodiments of the invention may obtain information from any applicable source or use any method in order to determine a screen is stable. For example, a capturing unit may interact with the application that produces a screen in order to determine that the screen is stable (e.g., the application is not modifying the screen) and may only capture a screenshot of the screen when informed the screen is stable. In other cases, a screenshot capturing unit may interact with a dedicated hardware component (e.g., a graphics subsystem) in order to determine a screen is stable, e.g., not being modified for a predefined period of time. In yet other embodiments, a sequence of screenshots of a screen may be captured (e.g., five screenshots per second may be obtained), and the sequence of screenshots may be used to determine the screen is stable, e.g., by determining a difference between a first and second screenshots in the sequence is below a predefined threshold. It will be understood that embodiments of the invention are not limited by the system or method used for capturing screenshots nor by the method or system used to determine a screen is stable.

In an embodiment, determining a screen is stable may be based on determining a portion or region of the screen is stable. Otherwise described, an embodiment may determine a screen is stable based on only a portion, section or region of the screen. For example, upon identifying or determining a portion of a screen is constantly changing or is otherwise unstable, an embodiment of the invention may exclude the unstable portion from consideration and may determine the screen is stable based on portions of the screen other than the unstable portion or region. For example, a region or section of a screen dedicated to banners or animated commercial content may be excluded from consideration or data used in order to determine a screen is stable. In other cases, a blinking cursor may be identified and may be excluded from considerations related to a stability of a screen. Accordingly, an embodiment may determine a screen is stable by masking out an unstable portion or region of a screen (e.g., an area dedicated animations, blink effects and the like) and examining or considering areas or portions of the screen other than the masked out area or portion.

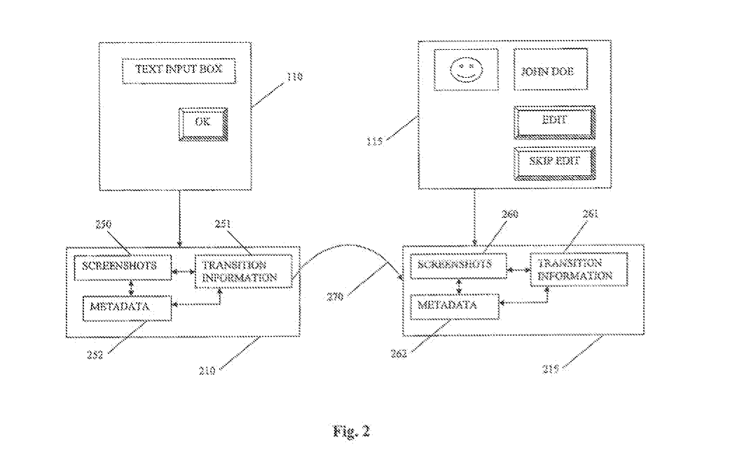

Reference is now made to FIG. 2 which schematically shows a representation of screens and related information or data in a model according to embodiments of the invention. As shown by 210 and 215, a model may include a screenshot, metadata and transition information. For example, screen 110 may be represented by, related to, or associated with screenshots 250 that may include one or more screenshots. Other modeling aspects related to screen 110 may be included in transition information 251 and metadata 252. Similarly, screen 115 and related aspects may be represented by screenshots 260 (that may include one or more screenshots), transition information 261 and metadata 262. As shown by 270, a transition or flow from screen 110 to screen 115 may be represented in a model. For example, transition information 251 (possibly referencing metadata 252) may include information related to a transition from screen 110 to screen 115. For example, transition information 251 may include a reference to 215 or any object included in 215. Metadata 252 may include any information, data or parameters related to screen 110, screenshots 250 and/or transition information 251. Transition information 251 may include any information related to a transition from screen 110 to another screen, e.g. and as shown by 270, to screen 115. Screenshots 250 and 260 may be screenshots of screens 110 and 115 respectively.

Although in some cases, a single screenshot may suffice in order to graphically represent a screen, in some cases more than one screenshot may be used. For example, a screen produced by an application may only reveal a part of a larger panel or screen. For example, a first screen or window displayed by an application may be resized and made smaller such that a resulting second screen or window only displays part of the information displayed in the first window. In such or other cases, scrollbars may be added to enable a user to scroll through the entire panel. Accordingly, screenshots 250 and 260 may include a number of screenshots that may provide different views or portions of a larger panel or screen. For example, a viewport having a size and/or shape may be defined and portions of a large screen may be presented through the viewport. As referred to herein, the term “viewport” is related to a region in a screen or display used to display a portion of a data element. For example, a viewport may enable seeing a portion of an image. Generally, a panel may be a data element and a viewport in a screen may enable seeing a portion of the panel. A panel may be for example a page in a layer that is below (e.g., existing but hidden by an element or image in a layer closer, virtually, to the viewer) the layer of the page including a viewport, accordingly, the viewport may be for example, a window that enables seeing or viewing a portion of the lower layer. For example, data in panel 730 may be viewed by viewport 720.

Embodiments of the invention may store, e.g., in screenshots 250, a number of screenshots (e.g., as shown by screenshots 250 and 260) that may represent a respective number of views that may be related to the same screen, e.g., a number of views provided by a viewport. When comparing or otherwise relating a captured screenshot to screenshots in a model or recorded session as described herein, the captured screenshot may be compared or related to a number of screenshots so that the portion visible through a viewport may be identified.

For example and as shown in FIG. 1, screen 120 may be a viewport into a larger panel or window that includes the button labeled “OK” and menu 186 as shown. As shown, in the viewport, menu 186 may not by fully visible. However, using scrollbar 187, other portions of the underlying screen, window or panel may be revealed or presented in the viewport. For example, in order to see menu 186 in full, a user may use scrollbar 187 to scroll down. In such exemplary case, an embodiment may capture and store a number of screenshots that represent a respective number of views of an underlying panel, screen or window. A number of screenshots associated with a viewport may be used in order to identify or determine an entire screen produced by an application. A number of screenshots associated with a viewport may be used in order to determine attributes of a large window or panel when only a portion of the window or panel is exposed in the viewport. Loosely described, an embodiment may use a number of screenshots as pieces of a jigsaw puzzle in order to determine the complete representation of a screen, window or panel. Accordingly, any screenshot of a portion of the window obtained at a later stage may be related to a window or screen determined as described herein.

For example, after capturing a number of different views of screen 120 achieved by dragging scrollbar 187, an entire view of an underlying panel may be determined. For example, an object similar to screenshots 250 may include screenshots of some or all views of screen 120. Accordingly, any view achieved by any position of scrollbar 187 may later be identified or determined as related to screen 120. Any algorithm or method may be used in order to associate a screenshot of a viewport to a set of screenshots representing a window or panel. For example, by compiling a representation of an entire screen, window or panel presented by an application based on a plurality of screenshots of portions of the entire screen or window, provided with a screenshot of a portion of the window, an embodiment may identify the provided screenshot as being part of the entire screen. Accordingly, an embodiment may identify a screen produced by an application even if only a portion of the screen is provided, e.g., through a viewport.

Control information related to a screen displayed in a viewport, e.g., a location of a button in the screen, may be recorded with respect to an underlying panel or window. For example, although the location or coordinates of a button that may be visible in a number of views in a viewport may be different in each of the views (e.g., the button may be at the top of a first view and at the bottom of a second view), the recorded location of the button may be with respect to the underlying panel, portions of which are presented in the different views.

Transition information related to a transition from a first screen to a second screen may be obtained, determined and/or derived by a module, unit or application. Transition information may be analyzed or processed, and may be stored, in the model or elsewhere, in association with the relevant screenshots. For example, screenshots 250 and 260 of screens 110 and 115 may be captured or otherwise obtained, and any transition information related to a transition from screen 110 to screen 115 may be obtained and stored in association with screenshots of screens 110 and/or 115, e.g., as shown by 251 and 261. Transition information may be any information usable to reference, represent, simulate and/or reproduce a transition from a first screen to a second screen, e.g., a transition from screen 110 to screen 115.

Transition information may include, or be related to, an event that caused the transition. For example, an event may be a click on button 181 (“OK”) in screen 110 that may cause the application to replace screen 110 with screen 115, accordingly, a click on button 181 in screen 110 may be identified as an event that may be stored in association with a screenshot of screen 110 (e.g., in transition information 215) and the event may further be associated with a transition from screen 110 to screen 115 (e.g., as shown by 270).

Embodiments of the invention may identify an event related to a first and second screens and may include information related to the event in the transition information. For example, transition information may include an event and a reference to an item. For example, transition information related to a transition from screen 110 to screen 115 may include a reference to screenshots of screens 110 and 115, information related to a mouse click and a reference to button 181. For example and as described herein, metadata 252 associated with a screenshot of screen 110 may include information related to button 181, including an identification parameter, and transition information related to a transition from screen 110 to screen 115 may include a reference to the identification parameter.

According to embodiments of the invention, a screenshot may be stored in a model if it is not already included or represented in the model. For example, upon receiving, capturing or otherwise obtaining a new screenshot, a module, unit, or application may examine screenshots included in a model in order to determine whether the new screenshot is already included or represented in the model. If it is determined that a screenshot is not included or represented in the model, the screenshot may be added to the model. Accordingly, a specific screen produced by an application may be represented once in a model even if the screen appears a number of times in a flow. For example, in order to represent or store a flow from screen 120 to screen 125 and back to screen 120 (as shown by arrows 160 and 165), a model may only store one representation for each of screens 120 and 125 and further store transition information such that the flow may be represented, tracked, displayed or reproduced.

In some embodiments, cases or scenarios, a first and second screenshots of a respective first and second screens may be obtained and, following an examination of a model, it may be determined that the screens are already represented in the model, e.g., by screenshots already included in the model. In such or other cases, an embodiment may further check if the specific flow or transition involving the first and second screens is represented in the model. If it is determined that the flow is not represented in the model, then transition information related to a transition from the first screen to the second screen may be added to the model, in association with the already represented screens.

For example, screens 120 and 125 may be represented or included in a model and the model may further include transition information related to a transition as shown by arrow 160. However, a transition from screen 125 to screen 120 as shown by arrow 165 may not yet be represented or included in the model. Accordingly, upon detecting a transition from screen 125 to screen 120 as shown by arrow 165, an embodiment may add (e.g., in association with a screenshot representing screen 125) transition information representing the transition shown by arrow 165. Accordingly, transition information may be added to a model with respect to screens already represented in the model, possibly without adding or modifying screenshots in the model. For example, upon identifying or detecting a transition from screen 110 to screen 115, transition information 251 may be updated in order to reflect or represent the transition, even if screenshots 250 and 260 are already stored or represented in a model. Accordingly, flows and transitions involving screens represented in a model may be dynamically updated, added or modified in the model, possibly without altering a representation of the screens.

In some embodiments, a reference to displayable data may be stored. For example, instead of, or in addition to a screenshot, a reference to a stored screenshot may be included in a model. In another exemplary embodiment, a uniform resource locator (URL) may be used as further described herein. Any operation related to a screenshot as described herein may be applied to displayable data for which a reference is stored. Accordingly, it will be understood that a discussion of a screenshot herein may be relevant to references to a screenshot.

As described, a representation of a screen and related events (e.g., as shown by 210 and 215) may include a pointer, link or other reference. For example, a URL may be included in representation 210. For example, in an embodiment, an application modeled, monitored or tracked may be a web browser. In such case, generating a model (or recording a session) may include storing one or more URLs used by a web browsing application. URLs may be used to model an application, record a session and monitor an execution. For example, instead of, or in addition to, recording screenshots as described herein, a URL may be recorded in a model or recorded session.

Operations and methods described herein may include searching for a screenshot in a model or recorded session or matching a captured screenshot with one or more screenshots in a model or recorded session. According to embodiments of the invention, rather than simply examining all screenshots in a model in order to find a matching or other screenshot, information in the model or recorded session may be used in order to quickly and efficiently find a screenshot. For example, given a captured screenshot for which a match in a model is needed, a title in the screenshot may be identified and screenshots in a model may be sorted according to a match level based on the title. For example, screenshots including a title which is the same or close to the title in the screenshot. For example, screenshot including a title which is identical to the title in the captured screenshot may be placed at the top of a prioritized list, followed by screenshot that include a title having the same length as the title in the captured screenshot and so on. In other examples, a list of candidate or potential screenshots may be prioritized according to a size of a window in a screenshot, e.g., screenshot including a window having the same (or close) size of a window in the captured screenshot may be placed higher in a prioritized list.

In yet other examples, e.g., when the application modeled is a web browsing application (e.g., a web browser as known in the art) a URL obtained from the browser may be matched against a set of URLs stored in a model or recorded session, a match level may be calculated for each of the URLs in the set and the URL associated with the highest matching level may be selected or the URLs in the model may be included in a sorted list according to their respective matching level.

By sorting or prioritizing potential screenshots as described herein, real-time and/or speed of operation may be served. For example, an application may produce hundreds or thousands of screens, accordingly, provided with a screenshot of a screen, identifying the screen (or its representation) in a model may involve examining or considering a very large number of screens. Rather than considering all possible screens in a model, an embodiment may improve the process by sorting potential screens according to a priority that may be calculated using any applicable information as described herein. Accordingly, the list of potential or candidate screens to be considered may be reduced. Sorting screenshots (or representations of screens) as described herein may be performed whenever applicable, e.g., when searching for a match in a model as described herein, when determining an expected screens etc. It will be understood that any method for sorting or prioritizing screenshots or other elements in a model or recorded session may be used, including any sorting or prioritizing methods known in the art. Any criteria may be used, e.g., any attribute of a screenshot such as, but not limited to, size, shape, color, fonts and the like may be used in order to sort screenshots according to a matching level. Any method for speeding a sorting process may be used. For example, metadata associated with screenshots as described herein may include a size, shape, color or any attribute of the associated screenshot that may be used by a sorting process when searching for a match or sorting screenshots as described herein.

A model may be tightly coupled to a specific flow, may be related to, or may represent, a number of specific flows, or may be related to an undefined or unlimited number of flows. A model tightly coupled to a specific flow may include screenshots of screens included in the specific flow and transition information related to transitions included in the specific flow. Similarly, a model related to a number of specific flows may include similar information or data related to the specific flows. A model related to an undefined or unlimited number of flows may generally include all known, identified or possible flows involving all identified or known screens and transitions.

Metadata may be associated with one or more screenshots in a model. Metadata associated with a screenshot in a model may be related to, or obtained from, any component, subsystem, application or entity. For example, metadata may be received from an operating system, from a graphics system or from the application producing the screens for which screenshots are captured. Metadata associated with a screenshot may be a product or result of processing or analyzing any data, parameters or information, e.g., analysis and/or processing of information received from an operating system, from a graphics system or from the application producing the screens.

In an embodiment, screenshots and related data may be examined, analyzed or otherwise processed. For example, any data, parameter or information related to an operating system, virtual machine (VM) or the application that produces the screens for which screenshots are obtained may be analyzed, examined or processed. Processing or analysis results related to a screenshot may be included in metadata and transition information that may be associated with the analyzed screenshot and may be stored, in association with the screenshot, in a model. Items or objects in a screen (or related screenshot) may be identified, recognized, classified or categorized and information or parameters identifying items and/or their attributes, may be included in metadata that may be associated with an examined screenshot. Accordingly, metadata associated with a screenshot may include any information related to items in the screenshot.

An embodiment may determine that an image of a screen includes one or more items and may represent the items in a model or recorded session by one or more parameters. The terms “item” and “element” in the context of a screenshot, screen or image of a screen as used herein refer to the same objects and may be used herein interchangeably. For example, a GUI element or GUI item may mean the same thing and may refer to any item, element or object in a screenshot or image of a screen. For example, it may be determined that screen 110 includes two items and the location and size of the items may be determined and recorded in a model. In order to model an application, a limited number of parameters may be required in order to represent items in a screen. For example, it may suffice to record a size and location of items in a screen in order to model an application. For example, by noting that an item is located in a specific location within a screen, identifying (and recording) a click on the item and identifying a subsequent screen produced, an embodiment may model an application, even without fully identifying the items in the screens produced. Accordingly, in an embodiment, screenshots and events related to an area in a screen may suffice in order to model an application.

For example, using screenshots and events in a model as described herein, an application may be modeled even if the functionality or other attributes of elements included in screens are not determined. For example, a flow of screens and events may be recorded and reproduced using screenshots and click or other events but without any additional information related to the buttons being clicked. For example, by noting and recording that a click on (a possibly unidentified) item located where button 181 is shown in screen 110 causes a transition to screen 115, using screenshots of screens 110 and 115, the application may be modeled and/or a flow including screen 110, a click on button 181 and a display of screen 115 may be recorded, graphically reproduced and/or used in order to verify an execution of the application. Accordingly, embodiments of the invention may enable modeling an application and recording sessions using only graphical information and high level event data (e.g., a click and a coordinate on a screen).

In other embodiments, cases or scenarios, items in a screen may be analyzed and their attributes may be determined and recorded. For example, GUI elements such as buttons, menus, input fields, images and the like may be recognized, identified, classified or categorized. Size, location (e.g., represented in relative coordinates with respect to the screen's borders), callback, color, functionality or any other attribute or aspect of elements, items or objects in a screen (or related screenshot) may be identified or determined. For example, based on its shape and size, button 181 in screen 110 may be identified as a clickable button. In other embodiments or examples, an API of a button (or other data) may be obtained (e.g., from an operating system or an application) and attributes or other relevant aspects of a button or other GUI object may be determined. Text or labels in or on items may be identified, e.g. using optical character recognition (OCR). For example, aspects related to button 181 may be determined based on the text (“OK”) on button 181. Any other algorithms, methods, processing or analysis may be applied in order to identify, recognize, classify or categorize GUI or other items in a screen or related screenshot. Any information related to items in a screenshot (or screen), e.g., determined as described herein, may be included in metadata associated with the screenshot. For example, metadata 252 may include any relevant information related to button 181 as described herein. In addition, metadata 252 may include an association of an identification parameter or value that may be used (e.g., in transition information 251) in order to reference button 181.

Metadata associated with a screenshot in a model may include any information or parameters describing elements in a screen. For example, metadata associated with a screenshot may identify a type of each item in a screen, e.g., a clickable button, a pull down menu, a text input box, an image, a label etc. Metadata may include, for one or more items, the location of the item in the screen, an indication whether or not the item may assume different locations, shape or size etc. In an embodiment, metadata associated with a screenshot in a model may include entries or records for some or all items or objects in the screenshot (and related screen). For example, an entry for an item or object may include an identification parameter or value, a type, a location, one or more categories with which the item is associated, a list of events that may be related to the item or any other relevant information.

Metadata associated with an examined screenshot may include information related to the relevant screen itself (or the related screenshot). For example, size, shape, location, borders, color or other attributes of a screen may be included in metadata associated with the screen or the related screenshot. For example, metadata 262 may include information related to the size and borders of screen 115, the number of items in screen 115 etc.

A screenshot, metadata and/or transition information may include links, pointers or other references to the same or other screenshot, metadata and/or transition information. For example, transition information 251 associated with screenshots 250 may include an identification of, or other reference to, data or parameter in metadata 252 associated with screenshots 250. Transition information 251 associated with screenshots 250 may include an identification of, or other reference to, data or parameter in metadata 262 associated with screenshots 260 or it may include a reference to 215 or any element included therein.

For example, metadata 252 associated with screenshots 250 may include an identification value for button 181. Transition information 251 associated with screenshots 250 and related to a transition from screen 110 to screen 115 (as shown by 270) may include information representing a mouse click (e.g., an event) and the identification value of button 181 or a reference to an entry of button 181 in metadata 252. Transition information associated with a screenshot of screen 110 may further include a reference to one or more of screenshots 260 or generally to 215. Accordingly, a transition from screen 110 to screen 115 as shown by arrow 150 may be represented in a model by references to screenshots 250 and 260, an event (e.g., stored or recorded in transition information 251) and an item associated with the event, e.g., an identification of button 181 stored in metadata 252.

Accordingly, any transition or flow from a first to a second screen may be represented in a model in a way that enables tracking, displaying or reproducing the flow. For example, an application that provides hundreds of screens where thousands of different flows or transitions between the screens are possible, may be modeled as described herein, wherein the modeling may include screenshots and information related to events, transition and flows as described herein. As described and shown, for each screen, a model may include a screenshot, metadata related to the screen and transition information related to possible transitions from the screen to other screens. Accordingly, tracking, debugging, verifying, displaying (or otherwise reproducing) screens, sessions, flows and/or transitions are enabled by embodiments of the invention.

Various systems and methods for recording screen or other related information are known in the art. Typically, in order to record information related to an execution of an application, known systems interact with an operating system and other components in a computing device in order to receive relevant information and information received is then stored. However, as known, even a simple move and click of a mouse may generate a large number of events, e.g., a large number of coordinate sets, interrupts, a “button down” event, a “button up” event, a “click” event and so on. Generally, events provided by an operating system may be categorized to low level events (e.g., “mouse down” and “mouse up”) and high level events (e.g., a “click” event). Other event types or categories exist. Existing recording systems and methods either records all events, only low level events, or only high level events. However, current systems and methods do not enable selectively recording events for a screen or for an element or object within a screen.

For example, it may be that, as designed or programmed, button 181 is activated by low level events (e.g., a “mouse down” followed by a “mouse up” events) and button 184 in screen 115 is activated by a high level event (e.g., a “click” event). Accordingly, in order to correctly interact with the application that produces screens 110 and 115, the correct events must be provided with respect to the relevant items. For example, in the above example, simulating or providing a “click” event to button 181 will not properly activate button 181 since, as programmed or implemented, button 181 requires the “mouse down” followed by a “mouse up” events in order to be activated.

Embodiments of the invention enable selectively recording events associated with a screen, or object in a screen, at any level or granularity based on a configuration. For example, in the above exemplary case involving buttons 181 and 184, a user may select button 181 in a model (e.g., by selecting a screenshot representing screen 110 in a model and further selecting button 181 therein) and may further indicate (e.g., using a selection menu) that a recording related to button 181 is to be low level. In the above exemplary case, the user may similarly configure recording related to button 184 as high level. Accordingly, when a session is subsequently recorded based on the model, an embodiment may examine the configuration parameters provided by the user (as stored in a relevant model) and automatically store low level events for button 181 and high level events for button 184. Accordingly, when a recorded session is replayed, the proper events will be provided to buttons 181 and 184, e.g., to activate button 181 based on a recorded session, low level events (e.g., a “mouse down” followed by a “mouse up”) will be produced and to activate button 184 based on the recorded session, a high level event (e.g., a “click” event) will be produced or provided to button 184 by a system according to embodiments of the invention. Accordingly, to record a session based on a model, embodiments of the invention may only store required events for objects interacted with. To record a session, embodiments of the invention may selectively store selected events for an object or screen based on a configuration. It will be understood that the above exemplary case involving low and high level events is a simplified example and that any criteria, rule or parameter may be used in order to selectively store events when recording a session and that any relevant configuration parameter may be configured, e.g., in a model in order to cause a selective storage of data when recording a session as described herein.

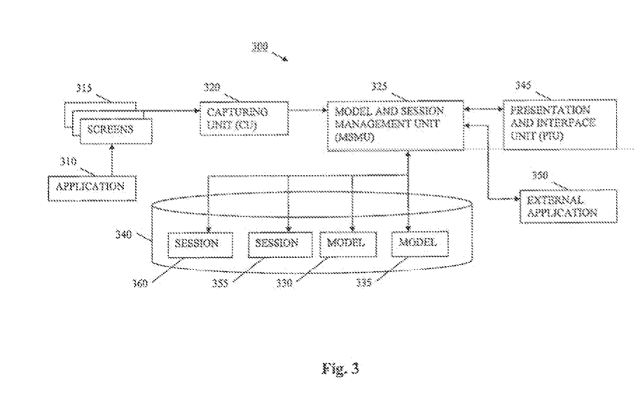

Reference is now made to FIG. 3 which shows a high level schematic block diagram of a system 300 according to embodiments of the invention. As shown, a system may include a capturing unit (CU) 320, a model and session management unit (MSMU) 325, a presentation and interface unit (PIU) 345 and storage 340. As further shown, models 330 and 335 and recorded sessions 355 and 360 may be stored in storage 340. CU 320 may capture and provide screenshots of screens 315 produced by application 310. CU 320 may provide screenshots to MSMU 325.

As described herein, CU 320 may capture or otherwise obtain any relevant information and provide obtained information to MSMU 325. CU 320 may capture any event related to screens 315 and provide related information to MSMU 325. For example, mouse clicks or mouse hovering over a GUI object may be detected and/or captured by CU 320. Other events captured by CU 320 may be a keyboard being pressed, a touch-screen being interacted with, or an interaction of an application (not shown) with application 310. Yet other events captured by CU 320 may be related to, or generated by, an operating system (e.g., a software interrupt), an underlying hardware (e.g., a hardware interrupt). Generally, any relevant event may be captured by CU 320 using any method, e.g., as known in the art.

Application 310 may be any application that provides, produces, presents or displays screens 315. For example, screens 315 may be rendered on a display screen of a computing device. Any graphical output, in any format, may be obtained. For example, screens 315 may be stored (e.g., by application 310) in a file or memory. In other embodiments, e.g., when running a number of applications on a number of virtual machines (VMs) on a single physical machine, screen output may be sampled or obtained from a VM that may not be associated with an actual or physical display screen. It will be understood that embodiment of the invention are not limited by the type, system or method used for generating or providing application screens.

Any input and/or output to/from an application may be captured and used. It will be noted that input or output may be captured from or by physical and/or virtual devices or entities. For example, virtual devices as known in the art may be interacted with in order to capture information directed to or originated from an application. For example, an application modeled or monitored as described herein may be executed inside a hosting application (e.g., a browser engine) in which case related input and output may be obtained using an API of the hosting application (e.g., the browser). Accordingly, an embodiment may include modeling and/monitoring a number of applications at the same time on a single physical machine (e.g., a VM).

Screens 315 may include any items, elements or objects as discussed herein. For the sake of simplicity and clarity, only two models (330 and 335) are shown in FIG. 3, however, it will be understood that embodiments of the invention may store, manage or manipulate any (possibly large) number of models. Likewise, although only a single application 310 is shown, it will be clear that embodiments of the invention may model a large number of applications. Specifically, by modeling an application as described herein, embodiments of the invention may model any application based on screens produced by the application and related events. Accordingly, in order to model an application by an embodiment of the invention, information related to a logic or other aspect of the application is not required. In particular, embodiments of the invention may model an application without relaying on information related to logic or other non-visible aspects of the application being modeled.

MSMU 325 may generate, update or otherwise manipulate or manage a model, operations and methods related to generating, modifying or updating models described herein may be performed by MSMU 325. PIU 345 may graphically present a model, e.g., present a sequence of screenshots based on transition information in a model. PIU 345 may receive, e.g., from MSMU 325, any information included in a model and may use such or other information in order to enable a user to interact with a model. For example, PIU 345 may graphically present a model to a user by displaying screens and graphically representing flows or transitions, e.g., PIU 345 may present a model by displaying screens and transitions as shown in FIG. 1. PIU 345 may enable a user to modify a model. For example, based on user input, PIU 345 may remove button 185 from a screenshot representing screen 115 and an updated model in which button 185 is omitted from a representation of screen 115 may be generated and stored.

An updated model may be automatically generated. For example, modeling an early version of an application, model 330 may include representations of screens 110, 115 and 120 and transitions 150 and 155, but may not include any information related to screen 125. When a new version of the application that includes screen 125 is executed, a system may monitor the execution, and may relate the execution to model 330. For example, screenshots and transitions related to an execution of the new version may be captured as described herein and compared, or otherwise examined in relation to, model 330. Upon determining that screen 125 and a transition thereto are not represented in model 330, MSMU 325 may generate model 335 that may include information included in model 330 and additional information to represent screen 125 and related transitions, e.g., as shown by 160 and 175. In other embodiments, an update model may include references to an existing model. For example, rather than storing information related to screen 110, updated model 335 may store a reference to model 330, e.g., a reference to 210. Any combination of information and references may be included in a model.

In another example, based on user input, PIU 345 may remove a screenshot and/or transition from a model. According to user input, PIU 345 may change metadata, transition information and/or screenshots or other parameters in a model. For example, based on user input, PIU 345 may remove a screen or transition from a model to produce an updated model and may further store the updated model (e.g., in storage 340). In yet another example, a model may be updated or augmented based on a placeholder. For example, a representation of screen 115 may be removed by a user from a model and the user may further insert a placeholder (or a blank screen) to replace the representation of screen 115. Subsequently, e.g., when a session involving the relevant application is performed, the session may be tracked or monitored, and, following a click on button 181, a new (e.g., previously unknown) screen may be produced by the relevant application. Identifying a transition to a placeholder and provided with a screenshot of the new screen, MSMU 325 may replace the placeholder with a representation of the new screen. Similarly, elements within a screen may be replaced by blanks or placeholders and the placeholders may automatically be replaced by representations of actual elements based on screenshots captured in a subsequent execution of the modeled application.

As described herein, a session may be recorded based on a user session that includes executing an application, interacting with the application and recording screens, interactions and events in a recorded session by referencing data in a model from within a recorded session and/or storing differences or deltas in the recorded session. As further described, differences or deltas may be differences between screens displayed by the application and screens as represented in the model. Other differences may be related to transitions or events.

However, other methods of recording a session or generating a recorded session may be contemplated. For example, a session may be recorded, or a recorded session may be generated, based on a model even without executing, or interacting with, the modeled or relevant application. For example, as described herein, a model may be interactive. Accordingly, using an interactive model, a session or an interaction with the modeled application may be simulated and recorded, e.g., screens may be displayed and transitions may performed based on user interactions with a model (and not with the modeled application).

An interaction with a model may be recorded to produce a recorded session. In other embodiments, screens and events may be included in a recorded session using drag & drop techniques as known in the art. For example, to generate a recorded session, screens in a model may be dragged and dropped into the recorded session. Clearly, when recording a session based on an interaction with a model, or only based on in formation in a model (e.g., with no reference or relation to an execution of the relevant application), no differences are included in the recorded session since all screens, transitions and events in the recorded session are as included, or represented, in the model. Accordingly, a recorded session produced by interacting with a model (or otherwise based only on the model) may generally only include references to the model and no differences or delta information.

Following a generation of a recorded session based on an interaction with a model, e.g., as described above, the relevant application may be executed and interacted with and the recorded session may be updated, e.g., to accommodate or reflect differences between screens produced by the application and screens represented or included in the model (and referenced in the recorded session). For example, when recorded in a session based on a model, text input box 180 in screen 110 may be empty. However, when a session with the application is later held, automated, monitored, tracked and/or recorded, a user may enter a name in text input box 180. In such case, to record the session (or update a recorded session), data representing a difference between an empty text input box 180 (as in the model and in the originally recorded session) and text input box 180 including a user name (as in the later session) may be included in the recorded or updated session. In yet another recorded session where yet another, different user name is used, the difference recorded may reflect that other user name. A difference detected may be reported.

Accordingly, a plurality of sessions may be recorded by referencing a single model and each recorded session may store the relevant, particular difference between the recorded session and the model. Accordingly, a recorded session may be automatically updated in order to represent or reflect a difference between a recorded session and a model. A recorded session may include a difference between the recorded session and another recorded session. For example, a first recorded session may include a screen and a form included in the screen and the form may include or contain text that may be represented as a difference from an empty form as represented in a model. A second recorded session may represent different text or entries in the same form by recording a difference between the (possibly empty) form as represented in the model and the form as included in the second session or the second session may include a difference between the first and second sessions.

A recorded session may be automatically modified any time a difference between the recorded session and a subsequent session is identified, discovered or determined. For example, a user may review a recorded session, modify screens, events or flows in the recorded session and save the updated or revised recorded session. Subsequently, a session with the relevant application may be automated using the updated recorded session, or a session with the application may be tracked or monitored based on the revised recorded session, and differences between the updated recorded session and an actual session may be identified and the updated, revised recorded session may be automatically modified, e.g., in order to reflect the last actual session with the application.

As described herein, a recorded session may be used in order to automate an interaction with an application. For example and as described, based on a recorded session, a screen displayed by an application may be identified, an event or interaction with the application may be determined (e.g., based on the screen and transition information included in a recorded session) an event may be produced or provided (e.g., a click event may be simulated, executed or delivered to a selected GUI element on a display screen) and an expected screen may be determined. For example, based on a model or a recorded session, an embodiment may determine a subsequent screen to be presented by an application following an interaction with a currently displayed screen.

In case a screen displayed by an application is different from an expected screen, an embodiment may perform one or more actions. For example, if a screen displayed is different form a screen expected based on a recorded session, then the recorded session may be modified or updated such that the screen displayed is expected in a subsequent repay of the session. Additionally or alternatively, an error may be reported, e.g., a bug may be reported and the bug report may indicate the screen, the difference between the displayed screen and the expected screen and so on. Accordingly, a recorded session may be automatically modified, revised or updated, e.g., based on an automated interaction with an application.

In a typical case, a session recorded or created based on a model and possibly irrespective of an actual execution of the relevant application may typically be updated at least once, e.g., when such recorded session is used for the first time for an automated interaction with the application. For example, a model based on which a recorded session is generated may include screens as defined by a project manager. However, as implemented by a programmer, and consequently, as produced by the relevant application, screens displayed by the application may differ from screens in a model and, consequently, from screen in a session recoded based on the model. When a recorded session is used in order to replay the session, differences between the screens as included in the model and as actually displayed by the application may be identified (e.g., screens displayed by the application may be compared to those in the model) and the recorded session may be updated to include the differences. A subsequent automated interaction, based on the updated recorded session may require no further updates since the differences may already be represented in the updated recorded session.

It will be understood that an automated modification or update of a recorded session as described herein may be applicable to any recorded session, e.g., a recorded session created or generated based on a model as well as a recorded session that was previously modified by a user. For example, a recorded session may be modified by a user (e.g., text in a form may be removed or changed) and the modified recorded session may be saved. Subsequently, the saved (and modified) recorded session may be used, e.g., in order to automate an interaction with the application. When screens produced by an execution of the application are examined with reference to screenshots in the saved, modified recorded session, a difference may be determined and the recorded session may be automatically modified again. It will be understood that modified recorded sessions may be saved such that a history of modifications is maintained. For example, when modifying a recorded session, the previous recorded session may be saved and a new version of the recorded session (including the last modifications) may be generated and separately saved. Accordingly, similarly to comparing and graphically displaying differences between models as described herein, differences between recorded sessions may be graphically presented.

As shown by 350, a system according to embodiments of the invention may interact with an external application. For example, based on an event, a parameter stored in a model may be provided to an external system that may perform an action and/or return data based on a provided parameter. An event may be related to an execution or test of an application. For example, model 330 may be generated for application 310 and may include representations of some or all screens and transitions of application 310. Subsequently, application 310 may be executed or tested (e.g., following a release of a new version). Testing of application 310 may include capturing screens produced by the tested application 310 and relating them to model 330.

For example, application 310 may produce the screens and transitions shown in FIG. 1. Accordingly, information in representation 210 may indicate that a transition from screen 110 to 115 is possible but a transition from screen 110 to screen 125 is not possible. However, (e.g., due to a bug in its code), application 310 may display screen 110 and, following a click on button 181, display screen 125. An embodiment may capture screen 110 when displayed during the test run and identify its representation in model 330 (e.g., as shown by 210). Next, the click and screen 125 may be captured. However, based on representation 210, an embodiment may determine the transition from screen 110 to screen 125 is an illegal, inconsistent or an invalid transition (e.g., a bug as known in the art). An illegal or invalid transition may be an event that may be acted upon. For example, information included in 210 may include a reference to a bug tracking system and a condition (or event) such as an invalid transition. Accordingly, upon detecting or determining an invalid or illegal transition, a system may automatically interact with an external system, report the invalid transition and provide additional information, e.g., identification parameters of the relevant screens etc. Any other criteria, event or condition may be defined as an event that may be associated with an action. Accordingly, based on a model, a system according to embodiments of the invention may identify, in real-time, an event related to an execution of an application and may further perform one or more actions related to the event.

In some embodiment, an action may include enabling a user to modify or update a model, e.g., presenting a user with a graphical interface designed to enable a user to modify a model. For example, in the above example, rather than (or in addition to) reporting a bug, a system may enable a user to modify or update model 330 such that, according to an updated model, a transition from screen 110 to screen 125 is an acceptable, valid or legal transition. In other embodiments, e.g., based on a configuration parameter of MSMU 325, an updated model may be automatically generated, e.g., as described herein. In yet other embodiments, an external system may interact with a tested system. For example, upon detecting an event, MSMU 325 may interact with external system 350, e.g., may provide external system 350 with data and parameters as described herein, including a reference to application 310 (e.g., a process id as known in the art). External application 350 may then interact with application 310, e.g., terminate application 310.

It will be noted that the system shown in FIG. 3 is an exemplary system and that other systems or configurations may be contemplated without departing from the scope of the invention. For example, in an embodiment, CU 320, MSMU 325 and/or PIU 345 may be combined into a single unit or module. In other exemplary embodiments, MSMU 325 may be divided into a number of units, e.g., a screen matching unit, a screen update unit etc. In yet other configurations, external system 350 may interact with the system via PIU 345 and not directly with MSMU 325 as shown.

According to embodiments of the invention, a model may be displayable. For example, screenshots and flows included in a model may be displayed or graphically provided. As described herein, a screenshot included in a model may represent any graphical and/or displayable aspect of a screen. Accordingly, a screenshot may be used in order to reproduce an appearance of a screen, thus, a model may be used to graphically display screenshots. For example, PIU 345 may display screenshots included in model 330.

Displaying a model may include displaying or reproducing a flow. For example, PIU 345 may display transitions as shown by arrows 150, 155, 160. For example, following a rendering of one of screenshots 250 of screen 110, PIU 345 (or management unit 325) may examine transition information 251 and/or metadata 252 and identify a transition to screen 115, as shown by 270. Accordingly, based on at least transition information 251, at least one of screenshots 260 may be displayed subsequent to a display of the one of screenshots 250. Based on information in transition information 251 and/or metadata 252, a click on button 181 may be graphically indicated, shown or simulated as part of presenting or reproducing a flow.

For example, model 330 may include representations of screens 110 and 115 as respectively shown by 210 and 215, a similar representation of screen 120, representations of button 181 and 184 in metadata 252 and 262 respectively, and an association of a click on button 181 with a transition to screen 115 in transition information 251. In such case, model 330 may be used in order to display or graphically reproduce the session. For example, PIU 345 may extract model 330 from storage 340, render at least one of screenshots 250 on a display screen and, based on information in transition information 251 and metadata 252, graphically simulate or display a click on a representation of button 181 in the displayed screenshot. Next, based on transition information 251, PIU 345 may determine that one of screenshots 260 (representing screen 115) is to be displayed following a click on button 181 and may, accordingly, present the relevant screenshot. In a similar way, subsequent screenshots and events included in a session recorded as described herein may be presented.

Models may be compared or otherwise related. A difference between models may be graphically displayed. For example, a first version of application 310 that produces screens and flows shown in FIG. 1 may be modeled and modeling information may be stored in model 330. However, in this first version, screen 115 may not yet include button 185 (“SKIP EDIT”). For example, button 185 may be added in a subsequent, second version of application 310. The second or subsequent version of application 310 may be modeled and modeling information may be stored in model 335. At any later stage, PIU 345 may use models 330 and 335 in order to graphically display differences between the first and second versions of application 310. For example, PIU 345 may compare screenshots in models 330 and 335, identify differences and graphically display the differences. For example, button 181 included in the first version of application 310 but not in the second version may be highlighted. Other views provided may include a high level view of differences between models, e.g., areas where most of the differences exist, number of mismatching screens etc. It will be understood that since, as described herein, any difference or inconsistency between models may be determined, any view, statistics or other information may be generated and provided.

Embodiments of the invention may record a session. Recording a session may be done by referencing data included in a model. Conceptually, a model as described herein may be a recording of a session. As described herein, by including information such as, but not limited to, screenshots, events and transitions, a model may include any information required in order to graphically reproduce a session. A model as described herein, used for recording a session, may be used in order to monitor a real-time session and determine various attributes of the session, e.g., whether or not a real-time or other session includes screens or transitions not included in the recorded session.

Preferably, a session may be recorded by referencing a model or a number of models. For example, a session recorded as shown by session 355 in FIG. 3 may include references to model 330. A plurality of sessions may reference a single model, for example, sessions 335 and 360 may each include references to model 335. A recorded session may include references to a plurality of models, for example, recorded session 335 may include references to screenshots, metadata or transition information in both models 330 and 335.

For example, model 330 may include information describing, or related to, screens and transitions shown in FIG. 1. In such exemplary case, in order to record a session (e.g., as shown by session 355) that includes screens 110, 115 and 125 (according to transitions 150 and 170), session 355 may include references to information representing screens 110, 115 and 125 and flows 150 and 170 in model 330. For example, rather than storing a screenshot of screen 110 in recorded session 335, a reference to 210 may be stored in recorded session 335. Accordingly, any number of sessions may be recorded by referencing a single model. For example, by referencing screenshots and associated transition information and metadata in model 330, any flow including any one of the screens and transitions shown in FIG. 1 may be recorded.

According to embodiments of the invention, a method of recording a session may include capturing, receiving or otherwise obtaining a set of screenshots and events related to a session, comparing, matching or otherwise relating a received or captured screenshot or event with a screenshot or event included or represented in a model, determining a difference between the received or captured screenshot or event and the matched screenshot or event, and recording the session by recording the difference. Recording a session may include recording or storing a reference or identifier. For example, recording a session may include storing a reference to a screenshot, metadata and/or transition information in an existing model. In some embodiments, recording a session may include generating and storing any information, e.g., information included in a model as described herein.

To record events in a session, events captured may be compared or otherwise related to events in a model and references to matching events in a model may be used in order to record a session. Differences between captured events and events represented in a model may be used in order to record a session. Accordingly, recording a session may include recording a deviation, a difference, a change (or a delta as known in the art) determined by examining captured screens, events, transitions and flows and respective screens, events, transitions and flows included or represented in a model.

For example, when generated, model 330 may be related to an application that produces the screens shown in FIG. 1 and may include representations of the screens and transitions shown in FIG. 1 and related events (e.g., clicks on buttons) as described herein. When subsequently recording a session involving the application, CU 320 may capture a screenshots of screens produced by the application (and related events) and MSMU 325 may examine captured data based on model 330. For example, in a recorded session, MSMU 325 may determine that the user name entered in text input box 180 is different from the user name recorded in the model. MSMU 325 may determine a difference to be the user name in the session and may further record a reference to screen 110 (e.g., a reference to 210) in model 330 and information representing the difference between the captured screenshot and a screenshot in model 330. In order to reproduce the session based on the recording, the original screenshot may be obtained from model 330 and the difference may then be applied. For example, a screenshot of screen 110 may be obtained from model 330 and the user name in text input box 180 may be changed based on information in the recorded session. It will be understood that a recorded session may include references to an existing model as described herein as well as any other information. For example, screens and transitions in a model may be referenced in a recorded session and, possibly other screens or transitions (e.g., ones not included in a model) may be included in the session, e.g., as described herein with respect to a model.

It will be understood that recording a session may be an iterative process comprising receiving screenshots related to a session, matching the received screenshots with screenshots included in a model, determining differences between the received screenshots and the respective, matched screenshots, and recording the session by recording the differences, identifiers or references to the model, and possibly additional information, e.g., transition information or metadata. Similarly, recording a session may include capturing events, matching captured events with data in a model (e.g., metadata or transition information), determining a difference, deviation or change based on the captured events and data in the model and storing information related to the difference, deviation or change.

As described herein, any number of sessions may be recorded by referencing data in a single model. As described herein, a session may be recorded by referencing data in a plurality of models. A session may be related to any number of applications. For example, a session may include generating a document using a first application and sending the document using a second application. In recording a session that involves two or more applications, two or more models may be referenced in the recorded session. A recorded session may include references, differences, identifiers or other information as described herein that may be related to a number of models. A number of models referenced or otherwise associated with a recorded session may be related to a number of (possibly different or unrelated) applications. For example, to record a generation of a document, a model of a word processing application may be referenced such that screens related to editing a document may be recorded by referencing screenshots and events in the model of the word processing application. Similarly, to record sending the document, references to a model of an electronic mail application may be used. Accordingly, by including references to models related to a number of applications in a single recorded session, a session involving any number of applications may be recorded.

A method according to embodiments of the invention may include graphically displaying a difference between a first and a second recorded session. For example, based on relating a respective first and second session recordings, a difference between the sessions may be presented. For example, a difference between a first and second screenshots included in a respective first and second recorded sessions may be presented, e.g., in overlay or by presenting screenshots side by side. A difference in flows may be graphically or otherwise presented. For example, based on information included in transition information in two different recorded sessions, differences between flows may be graphically shown. For example, flows common to a first and second sessions may be displayed using curves or arrows having a first color and flows or transitions included in a first session and missing in a second session may be identified and displayed by curves or arrows in a specific color that may be a different from the first color.

A method according to embodiments of the invention may include graphically displaying a difference between a first and a second models. For example, differences between screenshots and flows may be identified, indicated and displayed. Screenshots and flows common to, or included in, compared models may be indicated and displayed. Presenting a difference between sessions or models may include displaying information derived based on the compared sessions or models. For example, comparative statistical information related to the most popular screens or flows may be displayed, e.g., as pie charts or other graphical elements.

As described herein, a model of an application may be generated based on an execution of the application. A session involving an application may be recorded based on screens, events and other information related to an interaction with the application. Other than screens and events and other information obtained and recorded as described herein, various other information, parameters or data may be obtained and/or calculated. For example, when tracking an execution of an application, any relevant information may be obtained, stored or recorded in a model, recorded session or elsewhere. For example, a user name, a date and time, a duration, screens presented or any other data related to an execution of an application may be recorded or stored.

For example, when recording a session, a user name may be extracted (e.g., from text input box 180 in a screenshot) and stored in association with the recorded session. Other information, data or parameters collected and stored in association with a session or model may be a duration of a session, time required for a transition from a first to a second screen (e.g., as affected by available processing power), the number of invalid, or unexpected transitions encountered, any dynamic data or parameters entered (e.g., user name, password and the like), selections (e.g., in menus) etc. It will be noted that information obtained with respect to a session or model may be related to a 3^{rd} party system or application. For example, a recorded session related to an application may include information provided to the application by an external application, e.g., a database. As described herein, storing information related to a session may be accomplished by storing a difference from a model or from another recording of another session. From example, recording a user name may be accomplished by storing a difference of the current user name from a previous user name.

Operations and data related to a model or recorded session may be recorded. For example, an identification of the user who recorded, modified, or executed a model or session may be recorded, the number of changes that were made to a session or model, their dates and other parameters may all be recorded and may provided or presented at a later time.

Information collected may be processed, and processed data may be stored. Processed information may be related to a single session or it may be related to a number of sessions. For example, average session time may be calculated for a number of sessions. Average transition times may be calculated for a session or a plurality of sessions. Any other data may be generated and displayed, for example, related screens in two or more sessions or models may be compared and a comparison may be graphically presented etc. Accordingly, by recording any relevant information in a model or recorded session, embodiments of the invention may provide any relevant information with respect to an execution of an application. For example, any deviation from a previously recorded execution of an application (e.g., related to screens, event, time or duration and the like) exhibited by a subsequent execution of an application may be identified, recorded and/or reported.

Comparing sessions may be done in real-time. For example, CU 320 may capture, in real-time, events and screenshots of a session. For example, screens 315 may be produced by application 310 during a session including a user interacting with application 310. MSMU 325 may, in real-time, determine a difference between screenshots and events provided by CU 320 and screenshots and events in a recorded session. For example, capturing screenshots and determining differences may be performed in real-time as described herein, e.g., by comparing screenshots, metadata and transition information obtained in real-time with screenshots, metadata and transition information in a model or recorded session.

Embodiments of the invention may determine whether a session is compatible with a model or with another recorded session. For example, by relating or comparing screenshots, flows or transitions in a session to a recorded session, MSMU 325 may determine that a specific transition as included in a session is incompatible with a recorded session, e.g., such specific transition is not represented in the recorded session. For example, a session may be recorded in relation to an execution of a first version of an application. Following an update of the application, an updated model may be generated. The recorded session may then be related or compared to the updated model in order to determine whether it is compatible with the updated model. For example, a recorded session may be determined to be compatible with an updated model if all screens and flows in the session are represented or possible according to the updated model. An embodiment may verify or determine compatibility of a set of recordings with a model and may provide a list of all recorded sessions in the set which are compatible with the model or with an updated model. In another example, a list of all sessions in a set which are incompatible with a model may be presented or recorded. In yet another example, by determining differences between a model (e.g., of a new version of an application) and a set of recorded sessions, a list of all affected recorded sessions may be provided and/or stored. For example, all recorded sessions which are incompatible with a new version of an application may be generated based on the recorded session and a model of the new version.

In an embodiment, a recorded session determined to be incompatible with a model may be updated. For example, by recording differences between a recorded session and a model in an updated session, a compatible, updated session may be generated and may be used, e.g., for testing an application as described herein. In another embodiment or scenario, a user may manually correct or modify a session. For example, a user may remove or modify a representation of a screen from or in a session or a user may modify a transition in a session. Modifications made by a user may be marked. A modified or an incomplete session may be automatically updated or modified. For example, a recorded session may be examined in relation to a subsequent execution of the application and may further be modified based on the subsequent execution. For example, one or more screenshots in a recorded session (or in a model) may be updated or even replaced based on screens displayed by an execution of the application. For example, a user may review screens included in a model or recorded session, determine that a specific screen is to be updated and further remove the screen from the model or mark the screen as requiring an update. Subsequently, an execution of the relevant application may be monitored or tracked, e.g., screens produced by the application or transitions between screens may be examined with respect to the model or recoded session.

When identifying a new screen produced by the application that is not represented in the model, an embodiment may automatically add a representation of the new screen to the model. Likewise, when identifying a new screen displayed by the application that matches a representation of a screen in the model but is further different from the representation, an embodiment may automatically update the representation in the model according to the new screen. Similarly, transitions may be added or updated. Updating screens, transitions or other elements in a model or recorded session may be based on elements being marked. For example, a representation of a screen may be updated if the representation was previously marked by a user as needing an update.

At any point, e.g., when relating a received screenshot to screenshots in a model or recorded session, MSMU 325 may generate an event or perform an action. For example, upon determining, based on relating a received screenshot to a model or recorded session, that an invalid transition from a first screen to a second screen occurred, MSMU 325 may generate an event or perform an action. For example, an invalid transition may be a transition not included or represented in the relevant model. An action may include updating a model (or generating an updated model), e.g., by adding a screenshot, metadata or transition information to a model or by modifying data in a model. An action may include interacting with an external system or application as further described herein.

For example, based on a configuration parameter, upon detecting a transition in a session is not included or represented in a reference model or a recorded session, MSMU 325 may send an electronic mail (email) to a predefined recipient list where the email may include screenshots, metadata and/or transition information. Other indications, e.g., a popup window on a display screen or sound may be generated.

According to embodiments of the invention, a system or method may associate a screen produced by an application with a screenshot included in the model, identify or determine an event related to the screen and, determine a subsequent screen expected to be produced by the application based on the event and based on transition information included in the model. For example, following a matching of screen 110 with one of screenshots 250, and using information and/or references as described herein, MSMU 325 may examine transition information 251 and metadata 252 and determine that screen 115 is to be presented next by application 310 in response to a click on button 181. As described herein, references to button 181 and to a click event, as well as to one or more of screenshots 260 may be included in representation 210.

Accordingly, MSMU 325 may determine a subsequent or expected screen based on information in a model or recorded session as described herein. In cases where a number of possible screens may be produced or may be expected, a number of expected or possible screens may be presented. For example, based on transition information associated with at least one screenshot included in screenshots 260, MSMU 325 may determine that either screen 120 or screen 125 may follow screen 115 (as shown by arrows 155 and 170 respectively). Accordingly, provided with a screenshot of screen 115, MSMU 325 may identify related or expected screens and their representation, e.g., screenshots or other information related to both screens 120 and 125 in the above example. An expected screen may be determined based on information related to an event. For example, provided with an event related to a current screen, the set of expected screens may be determined, revised or reduced. For example, provided with a click event related to button 184, and based on transition information as described herein, MSMU 325 may determine that screen 120 is expected next and that screen 125 is not expected to be produced. Predicting a subsequent screen may be performed in real-time or with respect to a recorded session.

By determining an expected screen based on a displayed screen, an embodiment may determine or detect an incompatibility of an application with a model. For example, if, based on a model, screen 115 is expected following a click on button 181 in screen 110, then a display of screen 125 following a click on button 181 may be identified as an incompatibility with the model. Detecting an incompatibility may cause an embodiment to alert a user, record a bug etc. As described herein, detecting an incompatibility may cause an embodiment to update a model or otherwise generated an updated model or an updated recorded session. An incompatibility may be determined based on a recorded session. For example, if, according to a session, a transition from screen 115 to screen 125 is expected (e.g., this was the sequence recorded in the session) then a transition from screen 115 to screen 120 may be identified as an incompatibility or inconsistency with the recorded session. For example, a session replay may be halted upon detecting an inconsistency of a session with a recorded session.

By determining an expected screen, speed of operation may be served. For example, to automatically replay a session, an embodiment may identify a screen displayed by an application by relating a screenshot of the screen to screenshots included in a recorded session, determine an interaction to be performed (e.g., a click or a selection in a menu) based on data in the recorded session and further determine the next screen to be presented following the event (e.g., transition information described herein). Accordingly, an embodiment may determine, in advance, a screen to be displayed. Consequently, since an expected screen is known, determining that a displayed screen is indeed the expected screen may be achieved quickly, in real-time, by comparing a displayed screen to the expected screen. Moreover, an embodiment may determine a set of expected screens. For example, in case a number of screens may be displayed following a display of a first screen (e.g., both screens 120 and 125 may be displayed following a display of screen 115 as shown by FIG. 1), all possible or expected screens may be identified, e.g., based on transition information associated with the displayed screen. For example, transition information 261 may include references to representations of both screens 120 and 125, accordingly, determining a screen 115 is being displayed by an application, an embodiment of a method or system may identify screens 120 and 125 as expected screens.

As described herein, a session may be replayed based on a recorded session. Replaying of a session may be according to expected screens. For example, upon identifying a screen being displayed by an application, an interaction with the screen may be performed (e.g., a selection in a menu may be simulated) and an expected screen may be determined based on transition information or other data as described herein. An embodiment may then wait for the expected screen to be displayed. For example, following an automated interaction with a first screen, an embodiment may wait for the next, expected screen to be displayed. For example, following an identification of screen 110 being displayed and based on a recorded session, a click on button 181 may be automatically performed. Based on the recorded session, screen 115 may be determined to be the next or expected screen. Accordingly, a replay of the session may be halted until screen 115 is displayed by the application. For example, CU 320 may continuously capture screenshots of a screen and a replay of the session may only continue after MSMU 325 determines, based on screenshots provided by CU 320, that screen 115 is presented. Upon determining that the next or expected screen (e.g., screen 115 in the above example) is displayed, the next step in the session may be performed (e.g., a click on button 184). The next expected screen may subsequently be determined and so on. Accordingly, embodiments of the invention may replay a session according to screens, interactions and events regardless of timing or other considerations.

A list or set of screens identified or determined as expected screens may be prioritized. For example, based on a metadata indicating the number of times screens have been displayed in previous sessions (e.g., a popularity of a screen), based on information obtained from the application producing the screens or based on a value manually associated with screens by a user, expected screens may be sorted or associated with a ranking or confidence value. Various operations may be performed based on a sorting of expected screens. For example, in updating a model or recorded session, the screen at the top of a sorted list may be selected. In another case, a sorted list may be presented to a user who may select, from the sorted list, a screen to be included in a model or recorded session, e.g., in order to update a model.

Information in a model or session may be used in order to track or replay a session. A recorded session may be used in order to automate a replay of a session. For example, events in a recorded session may be used in order to interact with an execution of the application such that a user interacting with the application may be simulated. For example, a screen produced by the application may be identified in a recorded session by relating a screenshot of the screen with screenshots included the recorded session, an event associated with the screen (e.g., a click on a button) as recorded in the recorded session may be determined and executed. For example, a click on a button in a screen produced by the application may be automatically performed based on an event in a recoded session. An expected screen may be determined based on the recorded session (e.g., based on transition information as described herein). In another embodiment or usage, a session may be tracked or monitored. For example, screens and events included in a session may be captured and related to a model or recorded session.

For example, MSMU 325 or PIU 345 may use information in a model or recorded session in order to interact with application 310. In another embodiment, a separate session replay (or playback) unit (not shown in FIG. 3) may be used. For example, a playback unit may interact with PIU 345 or MSMU 325 in order to obtain access to any information in a model or recorded session. For example, PIU 345 or MSMU 325 may provide services to a playback unit, e.g., identify screens, determine events and the like. In yet another embodiment, a playback unit may be provided with screenshots (e.g., by CU 320), may directly access models or recorded sessions (e.g., in storage), and may perform any relevant operation, e.g., any operation described herein with respect to PIU 345 or MSMU 325. A playback unit may further interact with an application, for example, a playback unit may simulate an action such as a click on a button in a screen displayed by an application or selecting an item in a menu.

For example, application 310 may be executed and may present screen 110. Provided with a screenshot of screen 110, a playback unit may identify button 181 in screen 110 based on data in a recorded session, may examine references to transition or other information (e.g., 251 and 252 in (or referenced by) a recorded session) and may determine that button 181 is to be clicked. Accordingly, a playback unit may simulate a click on button 181 in screen 110 thus automatically interacting with application 310 to replay a session. Similarly, subsequent screens may be identified and interacted with such that a recorded session is repeated by interacting with the relevant application. An automatic replay of a session may include identifying events and deviations from a recorded session as well as performing related actions, e.g., generating an alert when a criteria is met. Accordingly, automatic debugging of application 310, including running sessions and reporting results may be automated, e.g., performed by a system according to embodiments of the invention.

For example, based on a recorded session (that may include a reference to a representation as shown by 210 or other data, e.g., transition information as described herein) and provided with a screenshot of a screen produced by an application, an embodiment may determine a screen that is expected to be produced next. If the expected screen is not provided, e.g., a different screen is displayed, a violation may be determined and an action (e.g., reporting and/or recording a bug) may be performed. An embodiment may wait for a screen determined as expected and, upon the expected screen being displayed, an interaction or event (e.g., a click on a button) may be performed based on transition information or metadata in a recorded session. Accordingly, an automated testing of an application may be performed and may be unaffected by conditions such as computing resources, speed of operation of a computing device etc. For example, an automated testing according to embodiments of the invention may be unaffected by timing considerations and may interact with an application based on screens presented by the application when they are presented.

Embodiments of the invention may enable modifying a recorded session or model, e.g., by a user. For example, PIU 345 may present a graphical view of at least a portion of a session. For example, screenshots and flows may be graphically presented by PIU 345 using images and arrows (e.g., as shown by FIG. 1). A user may interact with PIU 345 and may remove screenshots or flows from a session or model. For example, the transition from screen 125 back to screen 120 as shown by arrow 165 may be deleted from a session or model (e.g., in case the button labeled “BACK TO EDIT” is removed from screen 125). Likewise, a screenshot may be replaced by a user, e.g., a screenshot including the button labeled “BACK TO EDIT” may be replaced with a screenshot that does not include this button. In another case, a screenshot (or portion thereof) including sensitive or inappropriate information may be replaced.

As discussed, statistical information may be collected or derived based on a model or recorded session. For example, MSMU 325 may receive data related to a plurality of interactions with the application 310, may relate the data to a model to produce summary information and may graphically present the summary information. For example, each time MSMU 325 receives a screenshot of screen 110 it may increment a counter in metadata 252. Accordingly, a graphical presentation may be provided showing the number of times a screen is presented. Summary information may be specific to a session (e.g., the number of times screen 110 was displayed in a session) or it may be global (e.g., a cumulative counter).

Pie chart graphs may provide a percentage view or other aspects related to screens and events. Counters may be maintained for events (e.g., the number of time a button was clicked) flows and transition information in a model. Generally, any interaction with an application may be analyzed based on information in a model and an analysis result may be stored in the model and further used in order to present information related to interactions with the application.

A heat map may be generated for a model or a session. For example, based on counters included in metadata as described herein, statistical data reflecting the relative rate of presentation of screens may be graphically displayed. Similar data related to events or flows may be collected and presented. For example, an embodiment may present a set of thumbnails of screenshots and further highlight screenshots associated with screens presented more often than other screens such that areas (or screens) of the related application which are visited more than other areas or screens may be easily identified. Other aspects, e.g., time spent in screens may be similarly graphically displayed based on relevant data collected and included in metadata. For example, the time spent in each screen of an application may be determined. For example, time from presentation of a screen to transition to a subsequent screen may be recorded in metadata associated with the screen. In other embodiments, a coverage indicator for a session may be generated and graphically or otherwise provided. For example, a coverage indicator may enable a user to quickly identify areas or screens that were mostly interacted with in a session as well as identifying or see which screens were only visited a few times or not at all.

Based on a model or a recorded session as described herein, an embodiment may monitor or track an execution of an application. For example, screens produced during a session, related events and other information may be captured and examined with relation to a model or recorded session as described herein and any information, data or parameters may be determined or calculated and recorded. For example, the number of times a specific screen was displayed by an application may be determined and recorded by identifying the screen (e.g., based on its representation in a model) and incrementing a counter. Similarly, unexpected transitions, incompatibility with a recorded session or other events may be determined and recorded.

By correlating data in an external system with data in a model or recorded session, various views may be enabled and provided. For example, an identification of a representation of a screen in a model may be provided to a bug tracking system. When recording a new bug in the bug tracking system, the identification of the screen (e.g., an identifier of, or a reference to, representation 210) may be entered to the bug tracking system in association with the new bug. Accordingly, bugs in the bug tracking system may be related or correlated with screens represented in the model. Accordingly, a graphical representation of bugs may be provided by overlaying information in the bug tracking system on graphical or other data in a model or recorded session. For example, number, severity or other aspects of bugs as maintained by the bug tracking system may be overlaid on a graphical presentation of screens such that bug related information is overlaid on images of the screens.

For example, by combining information in a model with information in a bug tracking system, a graphical presentation of bug related information may be displayed, for example, by graphically displaying screens and further highlighting screens based on the number or severity of related bugs, e.g., screens associated with more than 20 bugs may be displayed with a red border. In another example, all screens for which bugs were found may be displayed and a heat map representing the number or severity of bugs may be overlaid on the displayed screens. In yet another example, screens may be displayed with a size that is proportional to the number of bugs, e.g., as presented, a screen with which seven bugs are associated may be larger than a screen with which only three bugs are associated. In other embodiments, a density of bugs in an application may be graphically overlaid on a presentation of the application's screen.

In an embodiment, PIU 345 may provide APIs that may enable an external system to display heat-maps based on statistical or other data provided by the external system. Accordingly, it will be understood that although a bug tracking system is mainly described herein, information from any 3^{rd} party application or source may be correlated with information in a model as described herein and that graphical or other representations of information included in a model and an external application may be combined and presented.

Information related to an execution of an application may be collected and/or provided to an external system, e.g., in real-time. For example, a bug tracking system and a system according to embodiments of the invention may share identifications of screens and, accordingly, density of bugs per screens may be presented. For example, upon detecting an invalid transition, a counter may be updated in metadata associated with a relevant screen or transition. In another embodiment, a reference to the relevant screen may be provided to an external bug tacking system. Accordingly, test results or other related information may be provided by a system to an external system. Provided with an identification or reference to screens or transitions determined to violate a condition as described herein, an external system (e.g., a bug tracking system) may produce statistical or other information. For example, each time an inconsistency related to a screen is identified as described herein (e.g., an invalid transition from/to the screen or a wrong item appearing in the screen are identified based on a model or recorded session) a bug tracking system may be provided with an identification parameter identifying the screen and possibly additional information. Accordingly, by collecting all references to the screen in the bug tracking system, various statistical or other information may be determined and displayed.

According to embodiments of the invention, a model may be interactive. An embodiment of a method of providing a an interactive model may include displaying a first screenshot included in the model, capturing an event related to an interaction with the displayed screenshot, and, based on the event, metadata and transition information in the model, selecting to present a second screenshot.

For example, a screenshot included in a model may be displayed on a display screen. Based on metadata associated with the screenshot, items or objects (e.g., buttons, menus etc.) may be identified in the screenshot and may possibly be marked or highlighted. A click or other interaction with an identified item in the screenshot may be captured and, based on metadata associated with the item and transition information, a transition to a subsequent screen may be simulated or performed. Accordingly, using a model, an interaction with a modeled application may be simulated in a transparent manner. Accordingly, a user may be unable to tell a difference between an interaction with an application and an interaction with an interactive model of the application.

According to embodiments of the invention, a method may include storing, in association with a screenshot, a parameter and/or condition, detecting a transition from the first screen to the second screen, wherein at least one of the screens is related to the screenshot, and providing the stored parameter to an external system, wherein the external system is configured to perform an action based on the provided parameter. For example, a model or a recorded session may include criteria or a definition of a condition that may be associated with a screen or transition. For example, an invalid transition or a mismatch of a screenshot. The criteria or condition may further be associated with an action and additional parameters. When screenshots and other information are obtained, e.g., in real-time, during an execution of a tested application, they may be related to the model as described herein and, if a condition or criteria are met or violated, the associated action may be performed. In another example, by monitoring, in real-time, screens produced by an application, an embodiment may determine, based on information in a model or recorded session, that an unauthorized user is interacting with an application. Such condition may be associated with an action that may be informing a security officer of a security breach. For example, the list of authorized users may be included in metadata associated with a login screen, accordingly, an attempt to login to an application may be detected and reported.

For example, metadata associated with a screenshot may include executable code or a reference to an external application. Metadata associated with a screenshot may include input parameters for an included executable code or for a referenced external application. Metadata may include a value, parameter, criteria or condition related to an execution of the included executable code or referenced external application. For example, external application 350 may be a database and a parameter stored in metadata 252 (e.g., by MSMU 325) may be a database key that may be used to retrieve an email recipient list from the database. A condition in metadata 252 may be, for example, the number of times screen 110 has been presented. For example, based on a counter described herein, if a specific screen is presented more than a predefined times during a single session then a criteria in metadata 252 may be met and a key in metadata 252 may be used to retrieve an email recipient list from a database and an email may be sent to the recipient list. Executable code, script and the like included in metadata 252 may be executed by MSMU 325 and may cause MSMU 325 to perform predefined tasks when predefined conditions are met. For example, upon a specific event or condition, MSMU 325 may generate an alert, store a snapshot etc.

Embodiments of the invention may synchronize or correlate an operation or execution of two or more applications. For example, an execution of a first application may be monitored by capturing screens and events related to the first application and conditions, rules or criteria may be checked based on captured screens and events, e.g., as described herein. An action associated with an event, rule or criteria may be included in a model or recorded session as described herein. The action may include interacting with a second application. For example, an action may include providing a second application with any information, for example, information generated by the first application. The second application may perform an action based on provided information. Accordingly, an operation or execution of the first and second applications may be coordinated, correlated, synchronized or otherwise related. For example, an operation of a bug tracking system may be effected by a report of an inconsistency of screens or flows as described herein. In another example, by monitoring or tracking an operation of an application (e.g., comparing screens produced by an execution of the application with screenshots and other information in a recorded session or in a model), a security application may be interacted with and may be caused to operate based on provided information, e.g., terminate the application if an unauthorized person attempts to interact with the application. A number of applications may be interacted with based on a single event or screenshot or based on a plurality of screenshots or events. Accordingly, by monitoring an application based on screens and events as described herein, embodiments of the invention may supervise an operation or execution of an application and/or coordinate an operation of one or more applications.

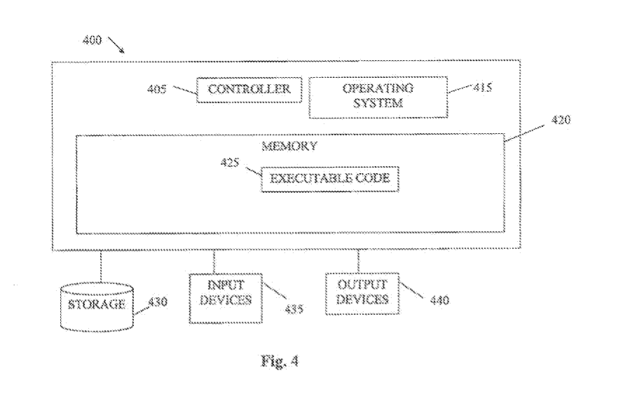

Reference is made to FIG. 4, showing high level block diagram of an exemplary computing device according to embodiments of the present invention. Computing device 400 may include a controller 405 that may be, for example, a central processing unit processor (CPU), a chip or any suitable computing or computational device, an operating system 415, a memory 420, a storage 430, an input devices 435 and an output device(s) 440, e.g., a monitor or display screen. Computing device 400 may carry out embodiments of the present invention.

Operating system 415 may be or may include any code segment designed and/or configured to perform tasks involving coordination, scheduling, arbitration, supervising, controlling or otherwise managing operation of computing device 400, for example, scheduling execution of programs. Operating system 415 may be a commercial operating system. Memory 420 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 420 may be or may include a plurality of, possibly different memory units.

Executable code 425 may be any executable code, e.g., an application, a program, a process, task or script. Executable code 425 may be executed by controller 405 possibly under control of operating system 415. For example, a controller such as controller 405 may execute executable code 425 which may cause the controller to perform operations described herein for example those with respect to CU 320, MSMU 325 and/or PIU 345. Where applicable, a processor executing executable code 425 may carry out operations described herein in real-time. Computing device 400 and executable code 425 may be configured to update, process and/or act upon information at the same rate the information, or a relevant event, are received. In some embodiments, more than one computing device 400 may be used. For example, a plurality of computing devices that include components similar to those included in computing device 400 may be connected to a network and used as a system. For example, generating and maintaining a model as described herein, or verifying a session may be performed in real-time by executable code 425 when executed on one or more computing devices such computing device 400.

Storage 430 may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in storage 430 and may be loaded from storage 430 into memory 420 where it may be processed by controller 405. In some embodiments, some of the components shown in FIG. 1 may be omitted. For example, memory 420 may be a non-volatile memory having the storage capacity of storage 430. Accordingly, although shown as a separate component, storage 430 may be embedded or included in memory 420.

Input devices 435 may be or may include a mouse, a keyboard, a touch screen or pad or any suitable input device. It will be recognized that any suitable number of input devices may be operatively connected to computing device 400 as shown by block 435. Output devices 440 may include one or more displays, speakers and/or any other suitable output devices. For example, screenshots or images of a display discussed herein may be screenshots or images of a display screen attached to computing device 400 as shown by output devices 440. It will be recognized that any suitable number of output devices may be operatively connected to computing device 400 as shown by block 440. Any applicable input/output (I/O) devices may be connected to computing device 400 as shown by blocks 435 and 440. For example, a wired or wireless network interface card (NIC), a modem, printer or facsimile machine, a universal serial bus (USB) device or external hard drive may be included in input devices 435 and/or output devices 440.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article including a storage medium such as memory 420, computer-executable instructions such as executable code 425 and a controller such as controller 405 may be included in a system according to an embodiment of the invention.

Methods and operations described herein may be performed by a system or by a computing device. For example, a system including components shown in FIG. 4 or a computing device similar to computing device 400 shown in FIG. 4 may generate and use a model as described herein. It will be understood that embodiments described herein may be performed by a dedicated or other hardware component or device that may include hardware, software or firmware or any combination thereof.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a server computer or any other suitable computing device. A system as described herein may include one or more devices such as computing device 400 and/or may include one or more components shown in FIG. 4.

Unless explicitly stated, the method embodiments described herein are not constrained to a particular order or sequence. Additionally, some of the described method embodiments or elements thereof can occur or be performed at the same point in time. Where applicable, the described method embodiments may be carried out or performed in real-time. A system including one or more components shown in FIG. 4 may process data and events at the rate data and events are received by the system. For example, computing device 400 may generate, maintain and use a model at the same rate screenshots and events are captured, thus providing real-time model generation, maintenance and usage.

A region of interest may be any region, portion or area in an image of a screen. For example, an image of a screen may be a screenshot of a display screen and a region of interest may be a specific region, portion or area in the screenshot. A region of interest may be defined, determined or identified based on elements in an image of a screen. For example, a region of interest may be defined, determined or identified by identifying GUI elements in a screenshot and defining (or identifying) a region, in the screenshot, that includes (or overlaps with) the GUI elements.

According to an embodiment of the invention, a computer-implemented method of automatically identifying a region of interest in an image of a screen includes identifying a set of elements in the image. An embodiment of a method may further include determining or defining a respective set of regions, each element in the set of regions respectively containing one of the set of elements. An embodiment of a method may include combining at least a first and second regions (or sub-regions) included in the set of regions to produce a composite region, and associating the composite region with an element in the image of the screen. Generally, any graphical objects, items or elements in a digital image may be identified, for example, identified elements may be a GUI button, a menu, a title in a screen and the like and regions (or sub-regions) that include, contain, enclose or confine an identified element may be defined. A composite region may include or be related to a number of elements presented on a screen or in a window. For example, a set of characters (e.g., a text string) displayed on a screen may be associated with a single composite region.

Generally, regions may be defined and recorded using coordinates, e.g., coordinates defined in a space defined by an image. Other method may be used. For example, sets of pixels in screenshots (e.g., as shown by 250) may be marked or referenced. For example, a set of pixels may be associated with a region by referencing the set in a list or other construct. Analyzing, processing, comparing, relating or otherwise manipulating images, screenshots, digital difference images (diff-images) and digital difference regions (diff-regions) may be performed based on digital representations as known in the art. For example, in an embodiment, relating screenshots includes comparing screenshots, for example, comparing pixel information of pixels included in representations 210 and 215 in order to compare images of a screen (or screenshots).

A method according to embodiments of the invention may automatically detect regions in a screen displayed by an application. A method according to embodiments of the invention may automatically identify and characterize regions in a screen. In an embodiment, regions detected or identified may be associated with metadata. Metadata associated with an identified region may include data or parameters defining or otherwise characterizing the region. Metadata associated with an identified region may include information or parameters related to an interaction an element, e.g., a GUI element presented on a screen. For example, a region may be detected, identified or determined such that it is closely related to a location, size, color or other attributes of a GUI element such as a button, a menu, a title, an image or other GUI elements.

Converting color digital images to grayscale (or black-and-white) images is known in the art. For example, an input color image may be converted to an output grayscale image by mapping colors and intensities in the input color image to shades of gray. For example, by associating pixels in a grayscale image with an intensity value that ranges between zero (representing black) and 255 (representing white) based on the color, intensity, or other attributes of the respective pixels in a color image, a grayscale image may be produced. Binary images are a particular case of grayscale images, in binary images, pixels are associated with one of two values, respectively representing one of two grayscales that may be black and white. Converting grayscale images to binary images is also known in the art. Likewise, morphological operations such as dilating and eroding are known in the art.

Contour detection is also known in the art. However, contour detection is often performed in the art following a smoothing operation to reduce noise (avoid having thousands of contours). With respect to computer generated image like an application UI, every pixel counts so you can't do smooth. As described, an embodiment of a method or system may include thousands or regions in a composite region. Using a grid as described, a large number of regions may be combined into a composite region in an efficient manner.

According to embodiments of the invention, regions containing or including contours and elements in a screen may be defined and/or determined. In an embodiment, regions containing or including elements such as text, images, clickable buttons, menus, lines and the like presented in a screen are defined. Regions containing or including contours or other elements may be placed on a grid having cells. For example, a contour may be an outline or curve that represents or defines a bounding of an element in a screenshot. The size of the cells in the grid may be dynamic and may be changed during a processing as described herein. A number of regions or sub-regions may be combined into a composite region. As described, an embodiment of a system or method may combine a plurality of regions (e.g., thousands or regions) to generate a composite region thus handling a large number of regions without losing data in the regions. For example, using a grid as described herein, regions may be combined into composite regions.

In an embodiment, the grid is a data structure that enables efficiently locating (or determining a location of) regions in a two dimensional plane. For example, using a grid as described, an embodiment of a system or method can efficiently and quickly determine all regions that overlap a point or area in a plane. Therefore, a grid as described may be used in an embodiment of the invention to speed up calculations related to regions, e.g., calculating or determining regions distance measurements, intersection of regions and/or unification operations (e.g., unifying two or more regions into one region).

A region (that may be a region as described, a composite region or a marked region) may be associated with a screen, e.g., by associating a region with a digital representation of the screen and recording the association, e.g., in a list or table, in an object that represents the region or in an object that represents the digital representation of the screen. For example, a representation as shown by 210 may include information related to a composite region. Any information related to a marked region may be recorded. For example, attributes of a marked region such as a dimension, shape, orientation or location may be recorded. Events such as user interaction may be associated with a composite region and the association may be recorded. Attributes or types (further discussed below) such as volatile, fixed, floating may be associated with a composite region. In an embodiment, a computer-implemented method of automatically identifying a region of interest in an image of a screen comprises identifying a set of elements in the image and determining a respective set of regions, each of the set of regions respectively containing one of the set of elements.

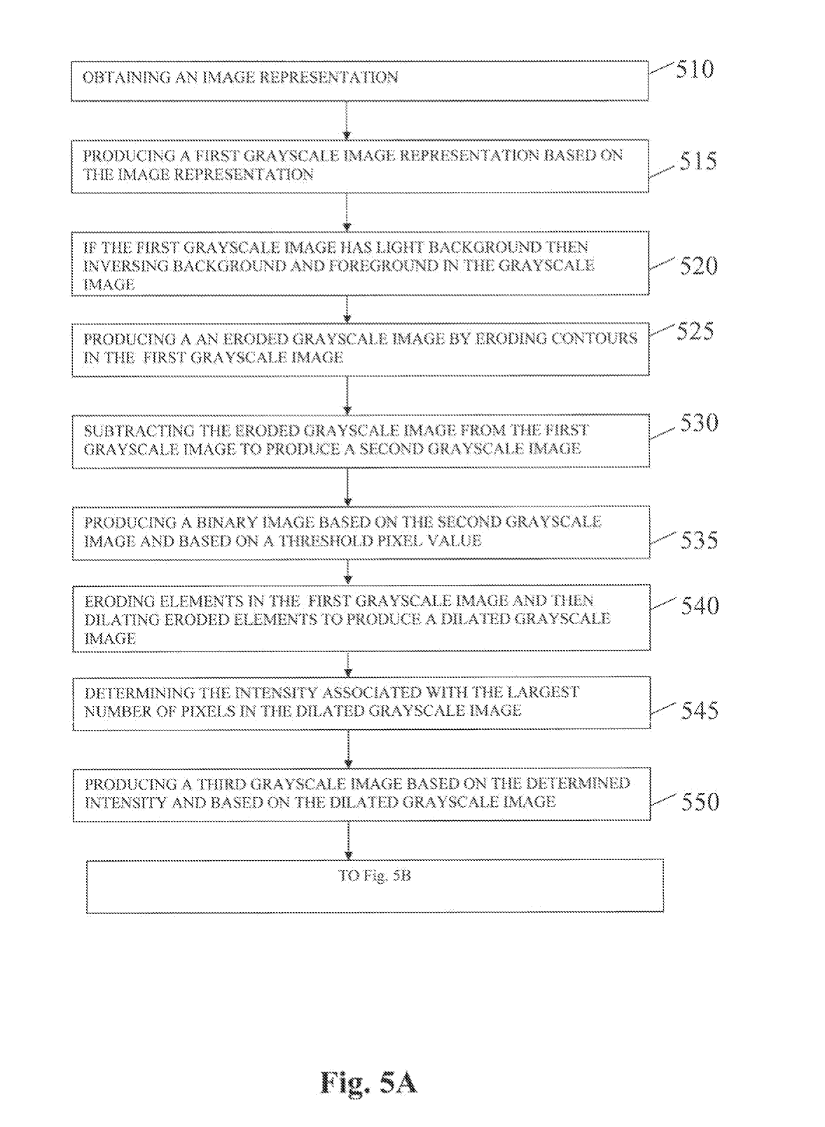

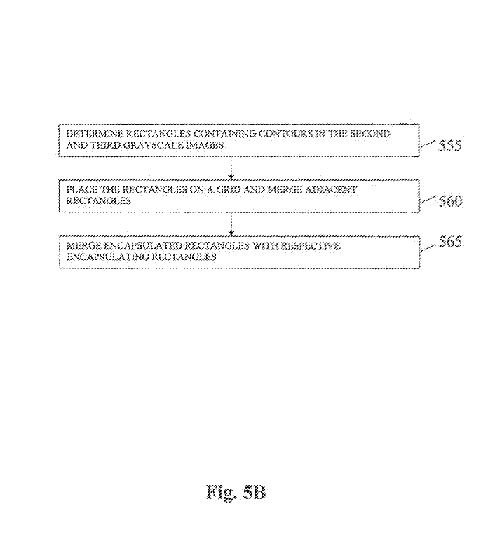

Reference is now made to FIG. 5A and FIG. 5B, which show a flowchart diagram illustrating a method for automatically identifying a region of interest in an image according to some embodiments of the present invention. As shown by block 510, an embodiment of a method or flow may include obtaining an input image representation. For example, a representation as described with respect to representation 210 may be obtained and stored, e.g., in a model. As shown by block 515, an embodiment of a method or flow may include producing a first grayscale image representation based on the input image representation. The first grayscale image may be produced as known in the art and briefly discussed herein.

The grayscale image may be produced based on a threshold. For example, white and light shades of blue in an input image may be represented as white in the binary image while dark blue and black are represented as black. A parameter related to a color, intensity or any other relevant value associated with pixels in an electronic image may be used to generate the binary image.

The first grayscale image may be produced such that the background is distinguished from the foreground. As further described, identifying elements may be based, at least in part, on the first grayscale image. For example, as shown by block 520, if the first grayscale image has a light background then it may be replaced by its negative image. For example, an embodiment of a method or flow may include inversing the background and the foreground in the first grayscale image. Any other method may be used such that the background in the grayscale image is dark and the foreground is light.

For example, a device, module or unit (e.g., MSMU 325 or device 400) may examine values of pixels in the first grayscale image and, if the majority (or more than half of) the pixels in the first grayscale image are above a threshold value than the values of all pixels in the first grayscale image may be inverted. In an embodiment, a negative or inverse image is produced only if it is determined that the background is bright such that in a resulting image the background is dark and the foreground is in lighter color. Any other operations or processing may be performed such that, in a resulting grayscale image, the background is darker than the foreground.

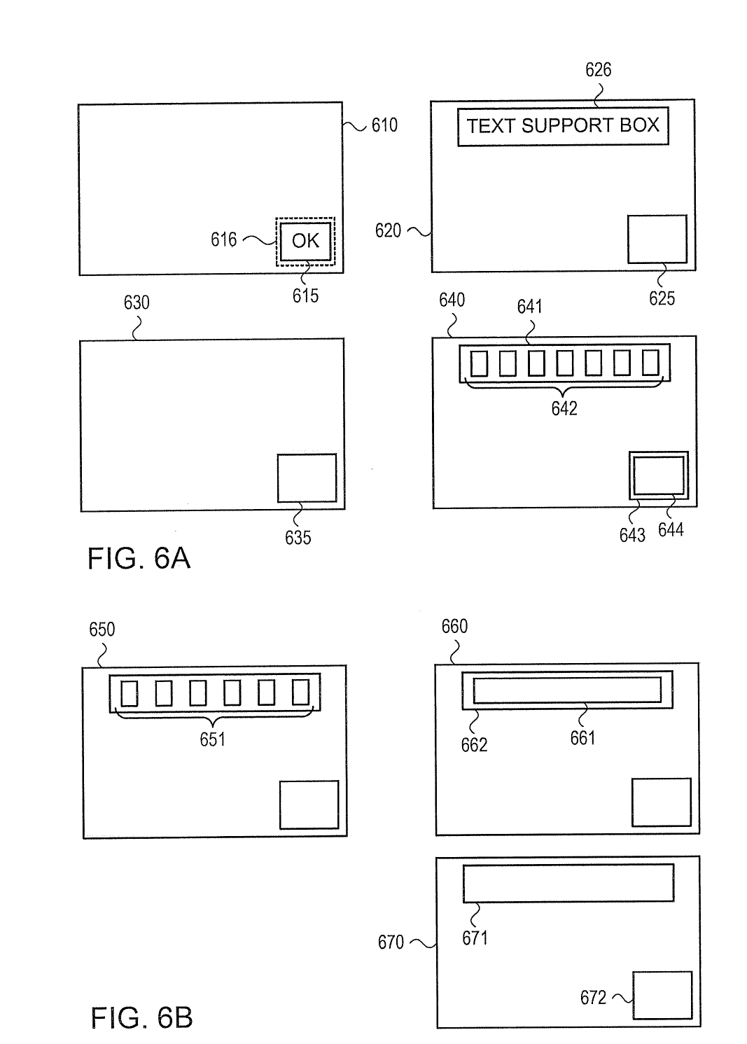

As shown by block 525, an embodiment of a method or flow may include producing an eroded grayscale image by eroding contours in the first grayscale image. As known in the art, by eroding elements in an image, elements may be smoothed and their size may be reduced. As known in the art, the level of erosion may be determined by a kernel used in the erosion operation. Reference is additionally made to FIG. 6A and FIG. 6B that show schematic diagrams of exemplary images according to embodiments of the invention. As shown, the eroded grayscale image 610 may be produced by eroding an image of screen 110 shown in FIG. 1. As further shown, thin lines or small objects may be removed (or cleaned) from an input image by eroding the input image. For example, as shown by 610, eroding an image of screen 110 may cause text input box 180 to be removed from the second grayscale image. For lustration, dashed line 616 in image 610 indicates the original size and shape of button 181 in an image of screen 110. As shown by 615, eroding an image of screen 110 causes a reduction in size of button 181.

In an embodiment, producing a second grayscale image comprises producing an eroded image by eroding elements in a first grayscale image and subtracting the eroded image from the first grayscale image to produce the second grayscale image.

As shown by block 530, an embodiment of a method or flow may include subtracting the eroded grayscale image from the first grayscale image to produce a second grayscale image. By subtracting the eroded grayscale image from the first grayscale image, frames or borders of elements in the original screen may be produced. For example and as shown by 625 in image 620, a frame or border of button 181 may be produced by subtracting the eroded grayscale image from the first grayscale image.

As further shown by 626 in image 620, thin lines (e.g., text) removed by the erosion of the first grayscale image may reappear, be reproduced, or reinstated, by a subtraction of the second grayscale image from the first grayscale image. For example, elements such as input text box 180 comprising thin lines or text may be removed by the erosion (accordingly, may not be present in the eroded grayscale image) but, since present in the first grayscale image, are reproduced by a logical subtraction operation. For example, a logical subtraction of a second image from a first image may include subtracting pixels' intensity as known in the art.

As shown by block 535, an embodiment of a method or flow may include producing a binary image based on the second grayscale image and based on a threshold pixel value. For example, based on a threshold value pixels in the second grayscale image may be assigned either the value of one (“1”) representing white or the value of zero (“0”) representing black. For example, pixels with an intensity value larger than 10 may be assigned the value of 255 and pixels with an intensity value smaller than 10 may be assigned a value of zero (“0”). Accordingly, the second grayscale image may be a binary image as known in the art.

In an embodiment, a binary image is generated based on the result of subtracting the second grayscale image from the first grayscale image. For example, based on image 620 that shows the result of subtracting the eroded grayscale image from the first grayscale image a binary image may be generated. It will be understood that converting a grayscale image to a binary image may be done during any step, stage or phase of the method. Any parameter or threshold may be used to convert a grayscale image to a binary image. For example, a threshold can be an intensity value, e.g., pixels in an input grayscale image associated with a value lower than or equal to ten (“10”) are assigned a value of zero (“0”) in a generated binary image and all other pixels in the binary image are assigned a value of one (“1”).

In an embodiment, identifying an element in an input image or defining a region containing the element includes converting the input image to a grayscale image and verifying the grayscale image has a dark background; removing elements from the grayscale image according to a threshold parameter; determining a range of intensity values associated with a majority of pixels in the input image; producing a binary image representing the determined intensity range; and identifying an element or defining a region based on the binary image.

For example, as shown by block 540, an embodiment of a method or flow may include eroding contours in the first grayscale image and then dilating eroded elements to produce a dilated grayscale image. As known in the art, an erosion of a grayscale image removes small elements and reduces the size of larger elements or smoothes large elements. In the resulting dilated grayscale image, edges of elements that were not removed by the erosion are smoothed. For example, following a sequence of eroding and then dilating a gray scale representation of screen 110, button 181 may be reproduced (although modified) but text input box 180 may be removed.

As shown by block 545, an embodiment of the method or flow includes determining the intensity associated with the largest number of pixels in the dilated grayscale image. Otherwise described, the intensity appearing with the highest frequency, or the most frequent intensity in the dilated grayscale image is determined. For example, a histogram of intensities of pixels in the dilated grayscale image may be generated and the intensity associated with the largest number of pixels is identified or determined based on the histogram.

As shown by block 550, an embodiment of a method or flow may include producing a third grayscale image based on the determined intensity in the dilated grayscale image. For example, to produce the third grayscale image, pixels in the dilated grayscale image not associated with the determined intensity are associated with a background value, e.g., zero (“0”). Accordingly, in one embodiment, the third grayscale image is a binary image as briefly discussed herein wherein pixels in the third grayscale image are assigned one of two possible values which are the background value of zero (“0”) and the determined intensity. By only representing the highest frequency in the third grayscale image, small elements in the input image are removed and larger elements are smoothed. For example, as shown by 635 in image 630, text input box 180 in image 110 may be omitted from the third grayscale image but a representation of button 181 is present therein. Regions including and/or identifying elements are identified, calculated or computed based on the second and third images as further described herein.

A region or area in an input image (e.g., image 110) that includes a number of small but separate elements may be identified. In an embodiment, a binary image produced as described herein (e.g., in relation to the second and/or third grayscale images described herein) may be used. Elements (e.g., lines or curves) along a specific axis in the binary image may be identified and recorded. For example, a binary is scanned with a horizontal kernel as known in the art such that only consecutive lines (having a specific width as determined by the kernel) are identified and included in an axis specific image. The axis specific image is then subtracted from the binary image to produce a subtracted image. The subtracted image is then expanded along the specific axis to produce an expanded image. The subtracted and expanded images are then merged or joined to produce a resulting image. Accordingly, a number of small and adjacent elements in an input image may be converted to a single element.

After detecting or identifying elements such as lines, regions that correspond to the elements may be defined, e.g., by recording the regions as described herein. Regions that correspond to lines in the subtracted or expanded images may be similarly identified and recorded. It will be understood that images may be expanded along more than one axis. For example, an image may be expanded along an “X” axis and along a “Y” axis. It will be understood that even if an embodiment of a system or method may subtract lines along or according to one axis, lines in a resulting image may be expanded along more than one and/or different axes.

By performing the above expansion, subtraction and joining of images, regions containing small elements such as text characters may be identified and/or defined. For example, by performing the above procedure or method, text characters in a title are joined together and a single region that includes all characters in the title is defined. Accordingly, an embodiment of a method may include producing, based a binary image, a first processed image, an axis specific image including consecutive lines along a selected axis; subtracting the axis specific image from the binary image to produce a subtracted image; expanding elements in the subtracted image along the selected axis to produce an expanded image; and merging the subtracted image and the expanded image to produce a resulting image. Regions including and/or identifying elements are identified, calculated or computed based on the resulting image as further described herein.

As discussed, the grayscale image based on which the second, third and/or then axis specific image described herein are generated may be generated based on a threshold parameter. For example, based on a threshold parameter, e.g., an intensity or color level, areas in an input image may be regarded as either background or foreground as described herein. The process of generating the second, third and/or the axis specific images may be repeated for a number of grayscale images generated based on a respective number of thresholds. Accordingly, regions uniquely related to a specific threshold values are identified. By using a plurality of grayscale images generated based on a respective plurality of thresholds, regions of interest that may have different colors or intensities are identified.

As shown by block 555 in FIG. 5B, an embodiment of a method may include determine rectangles containing contours or elements in the second and third grayscale images. For example, contour matching techniques known in the art may be applied to the second and third grayscale images described herein in order to identify regions that contain or include objects or elements in these images. In an embodiment, edge detection techniques may be used. Any method for determining or identifying regions or areas including any elements in the second and third images described herein may be used. For example and as shown by 640 in FIG. 6, regions (or rectangles) are defined based on images 620 and 630. As shown by 643 and 644, based on identified elements or objects as shown by 625 and 635 regions are defined.

As further shown by 641 and 642, regions for both a frame or an edge of text input box 181 and included text are defined. For example, in processing image 620 to define regions, after identifying the frame of text input box 181, a process may proceed to further identify objects or elements included in the frame, e.g., as known in the art. Accordingly, regions for any object or element, either including other elements, or included in other elements may be defined. For example and as shown by regions 642, a region for each one of the characters in input text box 181 may be defined by identifying elements in image 620.

Defining or identifying regions may be performed by defining a sub-region in a grayscale image and identifying a foreground element in the sub-region. For example, after identifying a region that corresponds to text input box 180, a sub-region contained by the identified region may be defined. By determining a background of the sub-region (e.g., by identifying a dominant intensity in the sub-region), a foreground element (e.g., the text) can be identified and distinguished from the background. Various methods for identifying or distinguishing a foreground from a background are known in the art and may well be used in order to identify a foreground element from the background. A region that includes foreground elements may be defined. For example, regions for each character in text input box 180 may be defined as described herein.

As shown by block 560, an embodiment of a method may include placing regions (e.g., rectangles) on a grid. For example, as shown by image 650, regions (or rectangles in a preferred embodiment) related to identified objects may be placed or defined in an image. As further shown by block 560, an embodiment of a method may include merging rectangles. Merging or regions may be based on any parameter, criteria, rule or threshold. For example, based on an adjacency, e.g., two regions touch (or are close to) each other, the two or more regions may be merged to produce a composite region. For example, an adjacency may be measured using a distance threshold. For example, if a distance between a first and second regions in image 650 is below a predefined threshold then the first and second regions are combined into a single composite region. For example, as shown by 661 in image 660, rectangles 651 in image 650 are joined into a single composite region 661.

For example, regions in adjacent grid cells may be combined. As discussed, grid cells dimensions may be dynamically changed. For example, after a first iteration that includes merging regions in adjacent cells, the grid cells' size may be decreased and a second iteration may be performed. Accordingly, the resolution by which regions are merged may be controlled by controlling grid cells' attributes, e.g., grid cells' size.

An embodiment of a method may include combining a first and second regions is based on an attribute such as, but not limited to, an adjacency, a dimension, a shape and/or a location. For example, a rule may cause combining regions based on a dimension. For example, small regions (e.g., as shown by 651) in an area of an image may be combined based on a rule related to distance and size of regions. A first and second regions having similar shape (e.g., round or square) may be joined, e.g., provided they are also within a predefined distance.

As shown by block 565, an embodiment of a method may include merging encapsulated (or contained) rectangles (or regions) with respective encapsulating (or containing) rectangles or regions. For example, as shown by region 671 in image 670, regions 661 and region 662 in image 660 are merged to produce composite region 671. As shown by image 670, although the original screen (110 in this example) includes a button, a text box and text in these two elements, by processing the original screen as described, actual regions of interest may be identified and/or defined. As shown, the identified regions are related to elements in the original screen and can be used to identify the elements.

An embodiment of a method may include combining a first and second regions based on an inclusion, an overlapping, a background similarity and a texture similarity. For example, as shown by region 671, regions 661 and 662 may be combined based on an inclusion of region 661 in region 662. Other rules that take into account attributes such as a similarity in the background or texture of regions (e.g., as determined based on the input image) may be used in combining regions. Accordingly, any rule, threshold or criteria may be used in order to combine two or more regions into a composite region.

As shown by 671, combining a first and second regions may include removing at least one of the first and second regions. For example, region 661 is removed from image 670 as shown. In an embodiment, regions included in or contained by other regions are removed such that only outer most regions are left in a representation. For example, small regions generated based on text characters (e.g., appearing on a GUI button) are removed when determining a region generated based on a frame of the button includes such small regions.

As shown by regions 671 and 672, composite regions may correspond to a GUI elements presented on the screen. For example, region 671 corresponds to GUI element 180 and region 672 corresponds to GUI element 181. A layout of an input screen (as represented by its input image) may be determined and recorded. For example, as shown by image 670, a general layout of screen 110 may be determined based on an image produced as described herein.

A computer-implemented method of automatically matching images of screens may include elements described herein with reference to the method of automatically identifying a region of interest in an image. Generally, matching images of screens as referred to herein includes determining a similarity between a first and second screenshots, images and/or any relevant digital representation of content presented on a screen of a computing device.

As described, a method may determine that a first and second images of screens match even if the content in the first and second images is not identical. Capturing screenshots, defining regions in screenshots and relating screenshots or content therein may be performed, as described herein, by a computing device, e.g., computing device 400 described herein.

A computer-implemented method of automatically matching images of screens may include obtaining a first screenshot of a screen, the first screenshot including a viewport exposing a portion of a panel. For example, a first screenshot that includes a viewport is obtained, stored and represented by system 300 as described herein.

As described, the first screenshot or image may include a viewport. Generally and as known in the art, a viewport is a viewing region, typically rectangle in shape, that provides, from a screen, a partial view of an underlying (or otherwise associated) panel. For example, a viewport in a webpage may partially show a panel, and scrollbars in the viewport may be used in order to control the portion of the panel being displayed by the viewport.

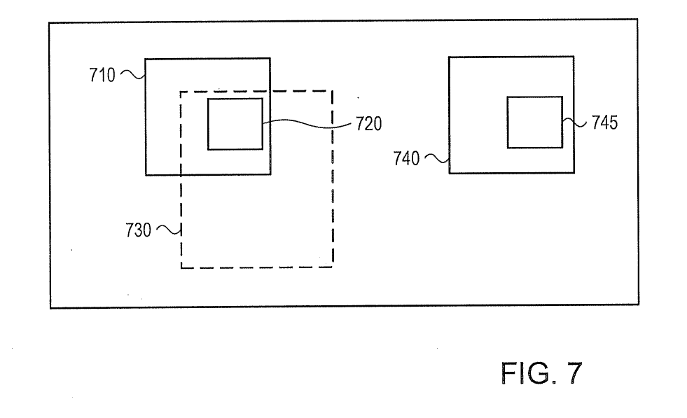

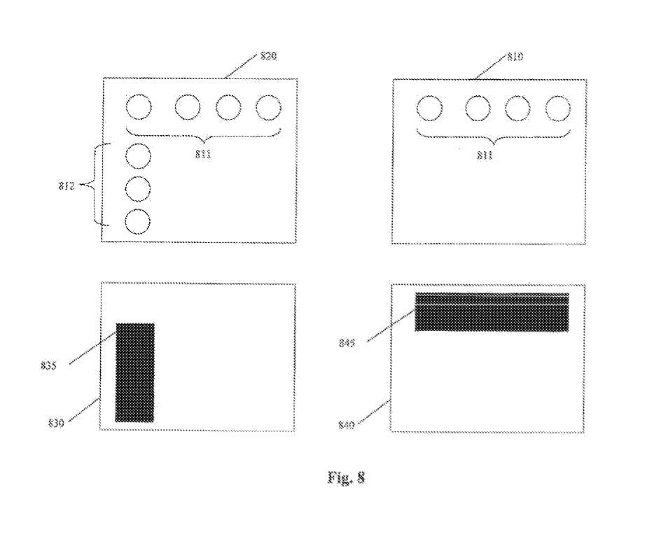

Reference is now made to FIG. 7 that schematically shows screenshots, regions and a panel according to embodiments of the invention. As shown, an image or screenshot 710 includes a viewport 720 that exposes a portion of panel 730. Viewport 720 defines a region in screenshot 710 and accordingly may be referred to as region 720 herein. Typically, viewport 720 includes scrollbars that enable a user to browse panel 730, in some cases, panel 730 can be moved with respect to viewport 720 (e.g., using click, hold and drag as known in the art).

Any data or parameters related to screenshot 710, viewport 720 and panel 730 may be recorded, e.g., in a model described herein. In an embodiment, screenshots of window 710 and panel 730 are stored and represented as shown by screenshots 250 and described in related text.

Data related to viewport 720 may stored as metadata. For example, attributes of the viewport such as coordinates defining viewport 720 within screenshot 710, a size, a relative location and the like are stored as metadata, e.g., in metadata 252. Accordingly, obtaining a first screenshot of a screen, the first screenshot including a view port exposing a portion of a panel may be accomplished by capturing and storing a snapshot in a model.

Data and parameters used for defining, identifying or characterizing a viewport may be obtained in several ways. For example, input from a user may be used to define a viewport. For example, using a GUI tool, an image of a screen (e.g., a screenshot or a still representation of a computer or other device monitor or display) is presented to a user by system 300 and the user draws a rectangle on the screenshot.

Input from a user, e.g., in the form of coordinates of a rectangle in a screenshot, may be stored in association with the screenshot and marked as a viewport in the screenshot. A viewport may be identified automatically. For example, by identifying a scrollbar within an image of a screen, it may be determined that the screen includes a viewport. In another case, by identifying dynamic content in a screen it may be determined that the region including the dynamic content is a viewport.

As shown by 740, a second screenshot may be obtained, e.g., captured as described herein. For example, during a development of application 310, a sequence of screens produced by application 310 is captured and it may be desirable to determine whether a first and second screens in the sequence match, e.g., are similar in some respect.

A process may determine whether or not the second screenshot 740 matches the first screenshot 710. As shown by region 745, a method of matching a first and second screenshots includes selecting, based on an attribute of the viewport, a region in the second screenshot. For example, the coordinates of viewport 720 stored in a model (and in association with screenshot 710) are used in order to define or select a region in screenshot 740.

To determine that screenshots 710 and 740 match, the content of region 745 may be related to content in panel 730. For example, content may be, or may include, an image, a text box or any GUI or other elements or items in an image or screenshot. Relating content may include comparing content. For example, content included in screenshot 710 may be compared to content included in screenshot 740; the two content items are thus related.

For example, by comparing pixels respectively representing screenshots 710 and 740, a system may determine screenshots 710 and 740 are generally the same, e.g., include the same image or element and therefore match each other. If screenshots 710 and 740 are determined to be identical then a system may determine they match. However, a match may be determined even if a first and second screenshots are similar but not identical.

For example, after obtaining screenshot 740 by CU 320, MSMU 325 defines region 745 based on the location, size and shape of viewport 720 and then crops, or obtains content included in, region 745. Next, MSMU 325 checks if the content obtained from screenshot 740 based on region 745 matches content in panel 730. It will be noted that content in region 745 is related to possibly all content in panel 730, not necessarily content exposed by viewport 720.

Many application screens can be uniquely identified based on content of an underlying panel, for example, in an application such as application 310, a single or unique panel may be associated with one specific screen. Accordingly, in an embodiment, by determining that content in region 745 matches content in panel 730, MSMU 325 determines screenshots 710 and 740 are similar, associated with the same screen or window, or otherwise match.

To determine a match, other regions may be considered. For example, a region (or area) around a viewport (e.g., a region around, or excluded by, viewport 720) and a corresponding region in a second image or screenshot (e.g., image 740) may be compared to determine a match between screenshots 710 and 740.

In an embodiment, rather than comparing, determining a similarity (or otherwise relating) content in region 745 to content in panel 730, region 745 is excluded from, or ignored in, a process of comparing or relating screenshots 710 and 740. For example, if it is known that content in panel 730 is dynamic, it may be desirable to ignore content in panel 730 when attempting to match screenshots 710 and 740. For example, prior to comparing screenshots 710 and 740, pixels in region 745 and in a region defined by viewport 720 are set to a predefined value and, accordingly, the content in these regions is ignored in a subsequent comparison between screenshot 710 and screenshot 740. Any other method of ignoring region 745 and viewport 720 may be used, e.g., a process may be made to skip comparison of pixels in regions defined by 745 and 720.

In addition to attributes such as a size, shape or location of the viewport used to define a region in the second screenshot as shown by 745, content in the viewport as represented in the first screenshot (e.g., screenshot 710) may be used. For example, if, by examining screenshot 710, a graphical element (e.g., an image or a GUI object) is identified in viewport 720, then region 745 may be defined such that it includes the identified element and may thus be smaller then viewport 720. For example, using techniques described herein, e.g., generating a composite region, a region containing the largest graphical element in viewport 730 may be defined and used to define region 745. Other criteria related to an object or element may be used to define a region that includes an element in viewport 730.

If region 745, defined based on an element in viewport 730 is determined to match a region in, or a portion of panel 730, then it may be determined that screenshots 710 and 740 match. Accordingly, in an embodiment, by identifying an element in a viewport as captured in a first screenshot (the viewport exposing content of a panel) a region in a second screenshot is defined. Based on relating content in the region defined in the second screenshot and the panel, a module determines whether or not the first and second screenshots match. Otherwise described, a method includes identifying a graphical element in a panel, the element exposed by the viewport as captured in a first screenshot, defining a first region, in the first screenshot, the first region including the graphical element, and, based on the first region, defining a second region in the second screenshot. In an embodiment, the second region is defined such that it is similar to the first region, e.g., having the same size, shape and location within an image of a screen.

In an embodiment, additional operations may be performed in order to determine a first and second screenshots match. For example, if both screenshots include viewports then the content exposed by the viewports may be compared in order to determine the two screenshots match. The content of underlying panels in both screenshots may be compared even if the panels are not fully exposed by their viewports. Content around (e.g., excluded by) viewports in both screenshots may be compared. Generally, comparing any content in a first and second screenshots may be done as described herein, e.g., using regions, grids and grayscale images as described.

Any suitable system or method may be used in order to represent regions, screenshots, images and/or snapshots discussed herein. For example, in order to represent a region, data such as relative coordinates may be stored, e.g., in metadata as shown by 252. In other examples, sets of pixels in screenshots (e.g., as shown by 250) may be marked or referenced. For example, a set of pixels may be associated with a region by referencing the set in a list or other construct. Analyzing, processing, relating, comparing or otherwise manipulating regions, images and/or snapshots may be performed based on a digital representation. For example, comparing snapshots may be performed by relating pixel information as included in representations 210 and 215.

In an embodiment, a method of matching images of screens includes generating a digital difference image. A digital difference image (also referred to as a diff-image) can represent one or more differences between a first screenshot and a second screenshot. If the first screenshot includes a viewport associated with a panel as described herein, the digital difference image can additionally represent one or more differences between the second screenshot and the panel.

A digital difference image (diff-image) may be generated using techniques known in the art. For example, an attribute such as an intensity in respective pixels in the first and second screenshots may be compared and a respective pixel in the digital difference image may be set to zero (“0”) if a match is found or one (“1”) if a difference is detected, e.g., the intensities of compared pixels are different. Reference is now made to FIG. 8 that shows a schematic diagram of exemplary screens and regions according to embodiments of the invention.

As shown, images 810, 820, 830 and 840 include graphical elements and/or defined regions. Images 810, 820, 830 and 840 may be screenshots or images of a screen captured as described herein. In an embodiment, 810, 820, 830 and 840 are screens or windows displayed by an application, e.g., application 310 described herein with reference to FIG. 3. In other embodiments, some or all of 810, 820, 830 and 840 are produced manually using any graphical or authoring tool known in the art.

As shown, image 810 includes graphical elements 811, image 820 includes graphical elements 811 and additional graphical elements 812, image 830 includes region 835 and image 840 includes region 845. Graphical elements 811 and 812 may be any graphical elements or objects presented on a screen of a computing device, e.g., GUI buttons, menus, titles, images and the like.

In an exemplary embodiment, image 810 is a first image, screenshot or snapshot of a screen as described herein (e.g., stored in a model as described herein), and image 820 is a new, subsequent or second image, screenshot or snapshot of a screen.

Images 810 and 820 may be screenshots of screens produced by an application as described herein or they may be manually generated digital images of a screen. For example, images 810 and 820 may be obtained by capturing screenshots of screens produced by an application as described herein or an employee in a firm may, using graphical tools known in the art, produce these images. For example, during a development of an application, images of screens (possibly not yet implemented by the application) may be generated manually, e.g., as part of a product definition. It will be understood that embodiment of the invention may be applicable to images of screens presented by an application and captured as described herein as well as to manually generated screenshots or images.

As shown, graphical elements, objects or items 811 in the first image 810 are included in the second image 820. However, items 812 included in image 820 are not included in image 810. Accordingly and as shown by 835, a region including, containing or otherwise related to differences between images 810 and 820 may be identified and recorded. For example, overlaid on image 820, region 835 covers elements 812 which constitute the difference between images 810 and 820. A region representing a difference, e.g., region 835, may be referred to herein as a diff-region. An image containing or representing one or more differences and/or diff-regions may be referred to herein as a diff-image. Region 845 may be a region defined by a user, e.g., a marker, volatile or other region as further described herein. In other cases, region 845 may be a diff-region. For example, if elements 811 are text characters but characters appearing in elements 811 in image 810 are different from those appearing in elements 811 in image 820, then region or sub-region 845 may be a diff-region and may be included in image 830.

An image including one or more diff-regions may be generated and stored. In an embodiment, only parameters usable to reproduce an image including one or more diff-regions may be stored. For example, the relative coordinates of region 835 may be recorded and may be stored in association with images 810 and/or 820. It will be understood that complex and multiple regions related to differences between a first and second images, screenshots or snapshots may be identified and recorded, and that FIG. 8 shows a simplified example of a region of differences 835 (or “diff-region” as referred to herein). An image representing differences between a first and second images can be processed as described herein. For example, regions containing elements in a diff-image (e.g., image 830) can be defined or identified. In an embodiment, elements are identified in a diff-image and composite regions (defined as described herein) are defined within the diff-image and further used in order to determine whether or not a first and second images match.

Any difference between a first and second images may trigger defining a region, a diff-region or a sub-region in a diff-image, e.g., as shown by region 835. For example, a diff-region may be defined based on a presence of a graphical element in a first image and lack of presence of the element in a second image. A diff-region as shown by 835 may be related to a difference in color, shape, size or any other graphical or visual difference. For example, if the color of one of items 811 in image 810 is different from the color of the corresponding (or same) item in snapshot 820 an additional diff-region (not shown) may be included in 830, such that the difference in color, of an otherwise same element in images 810 and 820, is reflected by the diff-region. As referred to herein, a diff-image may be an image containing or representing one or more differences (that may be included in or contained by one or more diff-regions).

For example, a diff-image is generated by comparing pixels in a first and second images and setting values of pixels in the diff-image based on the comparison. For example, if the intensities of two respective (or compared) pixels in the first and second images are the same then the respective pixel in the diff-image is set to black (or “0”), otherwise, the respective pixel in the diff-image is set to white (or “1”). A diff-image may be processed the same way screenshots or images are processed as described herein. For example, regions that include or contain elements in a diff-image may be defined, as described herein, in a diff-image. Regions in a diff-image may be combined into a composite region as described herein.

In an embodiment, a module, e.g., MSMU 325, generates, by relating (e.g., determining a similarity between, or comparing) images 810 and 820, diff-image 830 that includes one or more diff-regions as shown by 835 and stores diff-mage 830 in association with images 810 and 820, e.g., on storage 340. In another embodiment, e.g., in order to save storage space, rather than generating image 830, parameters, e.g., coordinates, size or orientation related to diff-region 835 are calculated, determined or defined and only the parameters are stored in association with images 810 and/or 820. It will be realized that any means for recording a sub-region or a diff-region (such as region 835) in an image or with reference to an image may be used without departing from the scope of the invention.

Generally, if a diff-image, produced by comparing or relating a first and second images, contains or includes no elements, items, objects or diff-regions then it may be assumed that the first and second images match. However, in embodiments, a diff-image may be processed and a match between images may be determined based on a processed diff-image. For example, masks, sub-regions and/or filters may be applied to a diff-image or a diff-region and a matching may be determined based on a resulting diff-image or based on a diff-image and applied masks, filters, sub-regions or other processing of the diff-image.

In an embodiment, after generating a digital difference image (diff-image) representing at least one difference between one of: a second screenshot and a first screenshot and a second screenshot and a panel associated with the first screenshot, a sub-region in the diff-image is defined.

In particular, a sub-region that excludes a predefined border, edge or frame is defined in the diff-image. In an embodiment, content in the sub-region is ignored (or masked) when determining if the first and second images match. As described herein, in order to determine a match, a diff-image produced as described herein is examined. By applying a sub-region that masks out a border in the diff-image, differences between the first and second images related or confined to, or included in, a border area are ignored.

For example, as known in the art, a frame around a screen of an application may be set according to the operating system used. By ignoring a border area that includes the frame, MSMU 325 can examine two screenshots of a screen of an application, presented using two respective different operating systems, and determine the screenshots match, even though the frames or borders in the two screenshots are different. Any method of defining and excluding a border region may be used. For example, input from a user defining a border region may be received, stored, e.g., as metadata in 252 and used as described herein. For example, coordinates defining a border region may be calculated based on a rectangle drawn by a user on a screenshot.

Typically, important information is not presented by an application at edges of a window or screen, rather, important information is typically presented closer to the center of a screen. Accordingly, an embodiment of a system or method may assume it is safe to ignore noise at the edges without losing the ability to distinguish or match screens. For example, screenshots may be determined to be similar (match) based on information presented in their respective centers.

A border may be defined or detected automatically, without any user input. For example, a fixed amount (e.g., 20 pixels or 5% of the width/height) may be used by an embodiment of a system or method. In the case of a screen displayed by an operating system, an embodiment of a system or method may infer or receive the border from the operating system dynamically, e.g., using an API. Other embodiments of a system or method may obtain a screenshot that does not include a frame to begin with, e.g., using an API, an image without a border may be obtained.

Processing a diff-image (digital difference image) produced as described herein may include removing elements smaller then a threshold size from the digital difference image. A match between a first and a second image may be determined based on a processed diff-image. Any method known in the art may be used to identify objects or elements in a diff-image. Any method known in the art may be used to determine a size or other attributes of elements in a diff-image. For example, regions including elements generated as described herein with respect to FIG. 6A and 6B may be defined, in a diff-image. After regions including elements in a diff-region are defined, the size of the regions may be inspected and, regions (including elements therein) smaller than a threshold size may be ignored. Accordingly, based on a criterion related to regions that include differences, small or localized differences may be ignored when matching screenshots or images. By removing elements from a diff-image and then determining a match based on the diff-image, differences represented by the elements removed are effectively ignored. Otherwise described, differences between compared or matched images, related to small areas or regions, are ignored by removing small elements from a diff-image.

In an embodiment, to determine whether a first image matches a second image, a diff-image is generated. In an embodiment, a diff-image includes or represents differences between at least one of: the second screenshot and the first screenshot and the second screenshot and a panel associated with the first screenshot. For example, a diff-image can include one or more differences between screenshot 710 and screenshot 740. Additionally, the diff-image can include one or more differences between screenshot 740 and panel 730.

In an embodiment, a diff-image is generated as described herein, by a method of automatically identifying a region of interest in an image of a screen. For example, after differences between a first and second images are identified, the differences are represented in a diff-image. For example, image 830 is a diff-image related to images 810 and 820. Accordingly, a representation of differences in a diff-image may be or may include one or more elements in the diff-image.

In an embodiment, regions are defined in the diff-image. For example, regions that include or contain elements in the diff-image (where the elements in the diff-image represent differences as discussed) are defined in a way similar to defining regions that include or contain graphical elements as described herein. Composite regions can be defined or determined in a diff-image, e.g., by including, combining, removing or filtering out diff-regions in a diff-image.

For example, rather than using image 110 as input to the method described with reference to FIG. 6A and FIG. 6B, a diff-image is used as input, and regions as shown by image 670 are generated for the input diff-image. In embodiments, one or more regions or sub-regions in a digital difference image are defined, identified or determined and a processed digital difference image is produced by removing a representation of a difference included in the defined, identified or determined regions or sub-region.

In an embodiment, if a sub-region in the digital difference image matches identified or determined respective sub-regions in both the first and second screenshots then it is determined that the first and second screenshots match. In another embodiment, if a sub-region in the digital difference image matches identified or determined respective sub-regions in both the first and second screenshots then a processed digital difference image may be produced by eliminating the sub-region from the digital difference image.

For example, if elements 811 in image 810 are similar to elements 811 in image 820 but differ in color then a region (e.g., a composite or other region described herein) including elements 811 may be defined for each of images 810 and 820 (e.g., as described with reference to FIG. 6A and 6B). In this example, a diff-region related to the differences between elements 811 in images 810 and 820 would be as shown by region 845 in image 840. In this example, the diff-region (as shown by 845) and the regions defined for elements 811 as discussed would match as they will all have the same size, shape and location (or relative location) within their containing images.

By identifying a diff-region that matches regions in (or defined for) both the first and second screenshots, it may be assumed that, in similar locations, similar elements are present in both the first and second screenshots. Accordingly, a processed digital difference image is produced by removing a representation of a difference included in the diff-region, and based on the processed digital difference image it may be determined that the first and second images match. In an embodiment, a difference represented by a diff-region that matches respective regions in the first and second images may be ignored. For example, in the processed digital image, pixels included in a diff-region may be set to a predefined value, e.g., a value representing a background.

As discussed, a diff-region or sub-region in a diff-image may be determined to match regions in both the second image and a panel associated with the first image. Defining regions for a panel may be done as described herein by simply treating the panel as an image.

Accordingly, a diff-image representing differences between the second image and the panel may be produced as described herein. Further more, matching the second image and the panel may be done as described herein. For example, if a diff-region or sub-region in a diff-image matches respective sub-regions in the second image and the panel, then differences in the sub-region may be ignored as described herein. Accordingly, as described, a method that ignores differences based on matching a diff-region with respective regions in input images can determine that the input images match even if differences such as different text, in otherwise same elements, are present.

A method may include determining a sub-region in the digital difference image is contained in a similar respective region in at least one of: the second screenshot and the first screenshot and the second screenshot and the panel. For example, if similar or same regions are identified, determined or defined in the first and second images and a sub-region or diff-region identified in a related diff-image is contained by, or included in the regions identified in the first and second images then differences represented by the diff-region are ignored. For example, if two similar or same elements are present in the same respective location in both the first and second images then similar or same regions will be defined for the first and second images. If further, a small and local difference between the otherwise similar elements exists, then a diff-region that will be smaller than the regions representing the elements will be defined and will, accordingly, be included or contained by the regions representing the elements. A representation of a difference in a diff-region included by respective regions in a first and second images may be ignored or removed, e.g., as described herein. A method may determine if a diff-region is included or contained by respective regions in both the first and second images or in both the second image and a panel associated with the first image as described herein.

Images representing differences (diff-images, e.g., as shown by image 830) may be generated and stored in a model. Metadata associated with an identified region (e.g., a diff-region) in a diff-image may include identifiers, references or other parameters. For example, metadata associated with a region may designate, define or identify the region as a marker region, a floating region, a volatile region and/or a fixed region.

A method may include determining a sub-region in a digital difference image corresponds to at least one of: a region in a region in the first screenshot marked as a marker region or a region in a panel associated with the first screenshot is marked as a marker region. If no differences are included in the sub-region, then the method may include determining the second screenshot matches the first screenshot.

For example, a marker region may be defined as shown by 845 to include elements 811 shown in images 810 and 820 that may be a fixed title (e.g., large text) that appears at a top of a screen while the rest of the screen may be dedicated to dynamic or transient details such as user name and the like. For example, input from a user that identifies a region including elements 811 may be received and, based on the user input, region 845 may be defined and stored in a model with association to image 810 (that may be the first image). When image 810 is related to image 820 in order to determine if images 810 and 820 match, MSMU 325 may determine that a marker region is associated with image 810 and may examine a diff-image produced as described herein. In particular, MSMU 325 may determine, based on a diff-image, if differences between images 810 and 820 are present in a region marked as a marker region. If no differences are found in the marker region then MSMU 325 may determine that images 810 and 820 match. Accordingly, based on a marker region (e.g., a title) a method may determine a match between a first and second images.

A marker region may be defined using any relevant method or system. For example, elements 811 may be text characters comprising a title. A user may indicate that a region including elements 811 in image 810 is a marker region (e.g., by manipulating a rectangle such that it contains elements 811) and the input of the user may be used in order to define a marker region such as region 845. For example, coordinates of a rectangle defined by a user are stored and used to generate or define a marker region such as 845. For example, after receiving a definition of a marker region 845 from a user, MSMU 325 stores the coordinates of region 845 in association with image 810, thus, subsequently; marker region 845 may be used as described herein. MSMU 325 may further store, associated with the coordinates, a region type parameter that identifies the region as a marker region. Any number of marker regions may be defined in association with a snapshot, screenshot or image, for example, screens or images may be identified or matched as described herein based on two or more marker regions by repeating operations described herein for each defined marker region.

A system or method may determine, define, or receive definitions of, regions in an image and/or a panel associated with the image. Generally, a region of any type, size, location or having any other attribute may be defined in an image or panel. For example, a region in image 110 is defined and represented by storing in metadata 252 a set of coordinates usable to draw the region in image 110, overlay the region on image 110 or otherwise manipulate or associate image 110 and the region. Defining and representing the region may further include associating the coordinates with a region type. For example, a region type may be a marker region, a floating region, a volatile regions and/or a fixed region.

In an embodiment, a method of matching a first and second images or screenshots includes determining a sub-region in a digital difference image corresponds to at least one of: a region in the first screenshot is marked as a floating a region and a region in a panel associated with the first screenshot is marked as a floating a region.

A floating region may be defined and recorded. Generally, a floating region as referred to herein may be related to a graphical element (or set of graphical elements) that may appear, or be presented, anywhere in, or on a screen. For example, elements 812 may represent (or be) a popup menu that is displayed when a mouse right click is detected as known in the art. As known in the art, a popup menu may appear anywhere on a screen, e.g., near a cursor of a mouse when the right button of the mouse is clicked. Accordingly, the set of elements 812 may be identified and recorded as a floating region that may appear anywhere in image 820 thus representing, for example, a floating menu that can appear anywhere on the related screen. Generally, the size and/or content of a floating region are recorded and used in order to define, and later identify, a floating region. Typically, a floating region may be defined and/or characterized without associating it to a specific location within a screen or snapshot.

A floating region may be automatically defined, e.g., by CU 320 and/or MAMU 325. For example, a popup menu that may be presented by clicking the right button of a mouse may be presented in any location on a screen, e.g., it may be presented right next to the current location of the mouse cursor. Accordingly, a region associated with the menu may be identified as a floating region. For example, by identifying the difference between a plurality of otherwise same or matching screens is related to a region having the same size and content in all the screens but further having a different location within the screens, MSMU 325 may determine that the region is a floating region and may record its size, content or other attributes. In another embodiment, a screen (e.g., recorded in a model as described) is presented to a user and the user marks a floating region in the screen, e.g., by drawing a rectangle around the floating region. The size and content in a region marked by the user may be recorded (in association with the relevant screen or image) and used as described herein.

In an embodiment, a method of determining a match between a first and second images (the first image associated with a panel) includes determining at least one region in the first image or in the panel is marked as a floating region. For example, a definition of floating region may be included in metadata associated with an image or a panel, e.g., in metadata as shown by 252 and described herein in related text.

In an embodiment, the method further includes determining that a diff-region in a diff-image generated as described corresponds to a floating region in the first image or in the panel. For example, based on the size and shape of a floating region and the size and shape of a diff-region, it may be determined that the diff-region corresponds to the floating region.

In an embodiment, the method further includes determining that a sub-region in the second screenshot matches the diff-region in the digital difference image and also matches the region marked as floating in the first image or in the panel. If a sub-region in the second image matches the diff-region and further matches the region marked as floating in the first image or in the panel then a processed digital difference image is produced by removing a representation of a difference included in the diff-region in the digital difference image.

In an exemplary case where a first screenshot is associated with a panel and is further associated with (or includes) a floating region, an embodiment of a method or system may generate a digital difference image representing at least one difference, e.g., a difference between a second screenshot and the first screenshot, and a difference between the second screenshot and the panel. An embodiment of a method or system may include determining a sub-region in the digital difference image corresponds to at least one of: a region in the panel marked as floating and a region in the first screenshot marked as floating; determining a sub-region in the second screenshot that matches a sub-region in the digital difference image also matches one of the regions marked as floating; producing a processed digital difference image by removing a representation of a difference included in one or more sub-regions in the digital difference image, the one or more sub-regions corresponding to at least one of: one of the regions marked as floating and/or the sub-region in the second screenshot; and determining the second screenshot matches the first screenshot based on the processed digital difference image.

A floating region may be determined based on user input that may be received as described herein. For example, presented with the first image or with an image of the panel (both may be stored in a model and presented therefrom), a user can draw a rectangle around a floating region and the size, shape and content of the indicated floating region may be stored in a model.

In an example, a floating region may be determined or identified by observing that a region partially covers or hides elements in a screen. For example, by observing buttons which are ‘cut in half’ or are otherwise partially obscured or hidden by a region, a floating region may be identified. For example, an attribute of a region, e.g., a background or color, or a font style in a region may be different from a respective attribute of a screenshot. In another example, a background color in a region may be different from the background color of other elements in a screen or from the background of the entire screen. In such case, the region may be automatically identified as a floating region.

As discussed, a floating region (e.g., related to a popup menu) may appear anywhere on a screen. Accordingly, a difference between images of a first and second screens may be related to a location of a floating region. Consequently, at least one diff-region will be present in a diff-image produced for the first and second images where the diff-region may be in the size and shape of the floating region.

Although in some cases the diff-region may be in the size and shape of the floating region, in other cases it may be of a different size. For example, the diff-region may capture or include two different differences related to the two occurrences of the floating region in the two images. In such case, the size and shape of the diff-region may not match the size and shape of the floating region.

As discussed, a flow may first determine that the diff-region is related to a floating region, e.g., by examining floating regions as recorded in a model and identifying a floating region having the same size and shape of the diff-region. If a floating region (associated with the first image or panel) corresponding to the diff-region is found and a sub-region in the second screenshot that matches the diff-region in the digital difference image also matches the floating region than a representation of a difference included in the diff-region in the digital difference image is removed. For example, to match a region in the second image with a floating region in the first image or in the panel, content in the region in the second image can be compared to content in the floating region. Accordingly, a difference related to a location of a floating panel, menu or other object or element may be ignored.

Otherwise described, if a diff-region defined based on a difference between a first and second images matches a floating region in the first image and a region in the second image which is related to (e.g., matches) the diff-region is also related to the floating region then a difference represented by the diff-region may be ignored. The floating region may be defined for a panel e.g., panel 730 that may be, where applicable, substituted above with the first image. For example, a processed digital difference image is produced by removing a representation of a difference from a diff-region related to a floating region and, based on the processed digital difference image MSMU 325 determines if the first and second images match. For example, if no pixel is set in the processed digital difference image then MSMU 325 determines the first and second images match. It will be understood that any manipulation or processing of a digital difference image, e.g., removing a representation of a difference from the digital difference image, includes producing a processed digital difference image. MSMU 325 or another unit may determine a first and second images match based on any digital difference image or processed digital difference image described herein.

A method of automatically matching screenshots of a first screen and a second screen, the first screen is associated with a panel, may include generating a digital difference image as described herein. The method may further include determining a sub-region in the digital difference image corresponds to at least one of: a region in the panel marked as a marker region and a region in the first image screenshot marked as a marker region; and if no differences are included in the sub-region then determining the second screenshot matches the first screenshot. For example, a marker region as described with reference to region 845 in FIG. 8.

For example, MSMU 325 may examine metadata associated with the first image and/or the panel and determine if a marker region is defined in the image and/or the panel. If so, MSMU 325 can, for example, relate the coordinates of a marker region in the first image to the coordinates of the sub-region in the digital difference image and determine if they are related, e.g., same. Generally, the marker region criterion assumes that if a marker region in the first and second images is the same then the images match. Accordingly, if a region in a diff-image defined by overlaying the marker region on the diff-image includes no elements (or representations of differences) then it is assumed the images match.

A method of automatically matching screenshots of a first screen and a second screen, the first screen is associated with a panel, may include generating a digital difference image as described herein. The method may further include determining a sub-region in the digital difference image corresponds to at least one of: a region in the panel marked as a volatile region and a region in the first screenshot marked as a volatile region; producing a processed digital difference image by removing a representation of a difference included in the sub-region; and determining the second screenshot matches the first screenshot based on the processed digital difference image.

A volatility mask may be defined and associated with a screen, or with a screenshot of a screen. A volatility mask may include or may reference volatile regions that may be areas, portions, sections or regions of a screen, e.g., as represented in a snapshot. Generally, a volatility mask may be related to one or more volatile regions in a screen. A volatile region may be a region where graphical data presented may be dynamic, random or otherwise non-static. For example, a constantly changing or otherwise dynamic area of a screen may be determined or identified and may be included in a volatility mask. In another example, a side bar in a screen may dynamically present multimedia or other content (e.g., banners in a web browser); such side bar may be included in a volatility mask generated for the related screen. In an exemplary embodiment, by examining a set of snapshots of a screen, a module may identify a dynamic region and may add the dynamic region to a volatility mask associated with the screen. Any number of dynamic or other regions may be included in a volatile mask associated with a screen or screenshot. A volatility mask may be used in order to process or examine a screenshot. For example, regions included in a volatility mask may be ignored when comparing or relating snapshot. Accordingly, dynamic regions may be ignored when comparing screens, thus, for example, different banners presented in otherwise similar screens may be ignored.

For example, a volatile region may be defined and stored, e.g., in a model as described herein. Removing a representation of a difference included in the sub-region (or diff-region) related to a volatile region can be performed as described herein. Accordingly, a processed image based on which it is determined, e.g., by MSMU 325, that the first and second images match may be produced as described.

A method of automatically matching screenshots of a first screen and a second screen, the first screen is associated with a panel, may include generating a digital difference image as described herein. The method may further include determining the second screenshot matches the first screenshot if a set of representations of differences between the first screenshot and the second screenshot is confined by a confining a region in the digital difference image, and the confining region is smaller than a threshold value. For example, in an embodiment, MSMU 325 applies a set of filters to a digital difference image. A filter generally implements one or more rules or criteria and a processed digital difference image is produced based on the filter. In an embodiment, MSMU 325 determines a match based on a processed digital difference image. For example, in an embodiment, MSMU 325 is provided with a maximal size of a diff-region and, if all differences in a (possibly processed) digital difference image are confined by, or included in, a region smaller than the maximal size then MSMU 325 determines that the first and second screenshots match.

A method of automatically matching screenshots of a first screen and a second screen, the first screen is associated with a panel, may include generating a digital difference image (diff-image) as described herein. The method may further include determining the second screenshot matches the first screenshot if the number of pixels representing a difference in the diff-image is smaller than a threshold value. For example, MSMU 325 can count the number of pixels in a diff-image and, if the number is lower than a configured number then MSMU 325 determines the screenshots match. This filter or criteria may be applied after each filter applied to a digital difference image. For example, a set of filters related to a set of regions types, e.g., marker and volatile region types, may be sequentially applied to a digital difference image. For example, the output (processed digital difference image) of a first filter is provided as input to the next filter. The order of applying the filters may be configurable. One or more filters may be applied between each filter in a sequence of filters. For example, checking if differences are confined to a small region as described above may be performed between each of the filters.

Complex rules, criteria or filters may be applied to a diff-image and related screenshots. For example, a method of automatically matching screenshots of a first screen and a second screen, the first screen is associated with a panel, may include generating a digital difference image as described herein. The method may further include determining the second screenshot matches the first screenshot if a set of conditions as follows is met. A sub-region (diff-region) in the digital difference image (diff-image) matches an identified region in only one of: the second screenshot and one of the first screenshot and the panel. One or more identified regions in another one of: the second screenshot and one of the first screenshot and the panel are included in an area defined by the sub-region, and, the one or more identified regions are respectively present in the only one of: the second screenshot and one of the first screenshot and the panel.

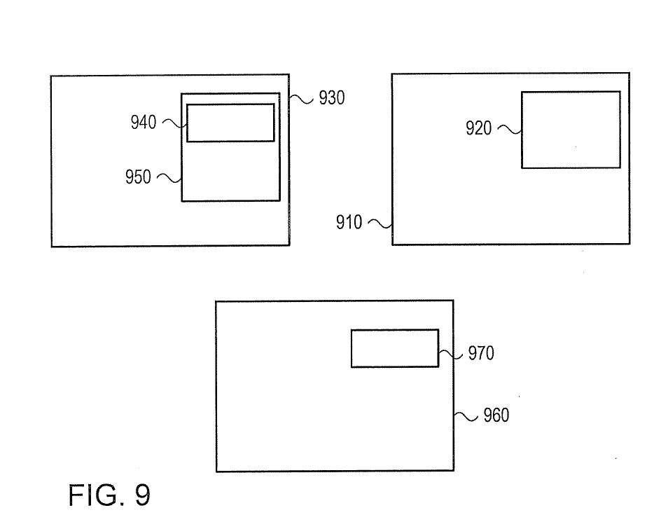

Reference is made to FIG. 9 which shows a schematic diagram of exemplary screens and regions according to embodiments of the invention. As shown, a diff-image 960 is generated for images 910 and 930. As shown, regions 920, 940, 950 and diff-region 970 may be defined. calculated or determined in as described herein.

For example, regions 920, 940 and 950 may be related to a menu that appears in both images or screenshots 910 and 930. However, in image 930 an additional region (region 940) is identified because an element in the menu is highlighted. For example, region 940 may be defined based on identifying a highlighted item in a menu, for example, a highlighted menu item having the size of region 920.

As described herein, regions may be identified based on a number of parameters, accordingly, regions 940 and 920 may be identified based on the menu and region 940 may be identified or determined based on a highlighting of an element in the menu. In turn, a region defined based on a highlighted item may contain additional regions that may be related to either highlighted or non-highlighted elements in the screenshots. By combining differences related to a highlighted element with a representation (or region) of an element that includes the highlighted element, an embodiment of a system or method may determine that a first and second images or screenshots match even though differences are found.

For example, it may be advantageous to determine that a first and second screenshots that show a menu match, even though an element in the menu is only highlighted in one of the screenshots. As described, embodiments of the invention enable automatically determining that such two screenshots match, e.g., may be treated as having not differences with respect to one another.

For the sake of simplicity and clarity, the example above is related to one highlighted element in a menu. However, it will be understood that any number of highlighted elements in corresponding menus may be present and handled in a similar manner. For example, the method described herein may be readily applied to a case where one menu item is highlighted in the menu in screenshot 930 and another, different menu item is highlighted in the menu in screenshot 910, accordingly, an embodiment of a method according to the invention may determine that two screenshots are of the same screen (match) even if different menu items are highlighted in each of the two screenshots.

Other regions may be defined as described herein, associated with a screenshot, with an image and/or with a panel. For example, region 845 may be a fixed region. For example, if the area including items, elements or objects 811 is known or determined to be fixed (e.g., same in a set of screens produced by an application) then region 845 may be defined as a fixed region, e.g., a region assumed to be, with respect to presented graphical information, static or fixed. For example, if elements 811 are fixed in size, color, location and/or other relevant attributes, a fixed region that includes or contains elements 811 may be defined as shown by 845. A fixed region may be used when determining whether or not a first and second images match. For example, knowing a specific region is fixed, an embodiment of a method or system may ignore the fixed region when comparing images or screenshots as described herein. In other embodiments, a fixed or predefined region may be used to define the only portion of screenshots which is relevant in determining whether or not the screenshots match. For example, an embodiment of a method may only compare content included in a fixed or predefined region in a first and second screenshots and, if content included in a fixed region in both screenshots is the same then the embodiment of the method may determine the screenshots match.

Fixed regions may be defined with respect to a screen, set of screens or snapshots. For example, a margin having a specific width around a screen may be defined as a fixed region. For example, a fixed region may be or may include a margin and may be ignored when relating or comparing screenshots. In another example, an outer portion of a screen may be determined or designated as a fixed region, and an examination or processing of a related snapshot may omit the fixed region (i.e., omitting or ignoring the outer portion of the screen) when processing or examining the snapshot. For example, a fixed region corresponding to edges of a screen may be used in order to automatically ignore the edges such that the screen may be automatically identified even if different edges or borders are used to present the screen. A rule or filter that ignores differences in fixed regions may be applied. A rule that determines a match between a first and second images based on a fixed region may be defined and applied.

According to embodiments of the invention, a method of automatically determining a screen is stable may include defining and recording regions as described herein for a first image or screenshot of a screen produced by an application. The method includes capturing a second screenshot of a second (or same) screen produced by the application, defining regions in the second screenshot as described herein and relating the first and second screenshots. If a match between the first and second screenshots is found or determined as described herein, it may be determined that the screen presented by the application is stable. A snapshot, image or screenshot of a stable screen may be stored in a model or in a recorded session.

One or more counters or thresholds may be associated with a snapshot or with a process performed by a module as described herein. For example, a stability counter and/or an instability counter may be associated with a candidate snapshot (e.g., a screenshot assumed as adequately representing a screen) or they may be associated with a process performed in order to determine whether a screen presented by an application is stable, or generally static. Generally, a stable screen as referred to herein may refer to a screen that does not change over time. A stable screen as referred to herein may refer to a screen that changes over time, but wherein changes are regarded as insignificant or acceptable, or where the changes are ignored.

According to embodiments of the invention, stability of a screen presented by an application may be automatically determined. For example, a plurality or sequence of snapshots (or screenshots as referred to herein) of a screen presented by an application may be acquired and processed, and a method performed by a system according to the invention may automatically determine that the screen presented by an application is stable. For example, CU 320 and/or MAMU 325 may perform a method of automatically determining a screen is stable described herein.

For example, when relating a sequence of snapshots of a screen to a candidate or other snapshot, a value of a stability counter may be raised or increased each time a matching is found. For example, if a screen as captured by a first snapshot is similar to the screen as captured by a second, subsequent snapshot, a value of an associated stability counter may be increased. Similarly, a value of an instability counter may be increased or raised each time a difference between snapshots of a screen is detected. Thresholds may be defined and used in conjunction with a stability counter and/or an instability counter in order to determine a screen is stable or unstable, e.g., as described herein. A level of similarity may be defined using regions. For example, the aggregate size of diff-regions in a processed difference digital image may be used as a measure of a similarity.

A match counter may be associated with a snapshot or with a process. For example, when relating a sequence of snapshots of a screen to a candidate or other snapshot, a value of a match counter may be raised or increased each time a match is found. Similarly, a value of an associated mismatch counter may be increased each time a mismatch between snapshots is found or determined. Accordingly, counters may be manipulated based on a match level related to a first and second images and the match level may be determined based on regions, diff-images and diff-regions as described herein.

According to embodiments of the invention, a screen may be considered stable if it does not change over a period of time, or if changes are determined to be insignificant. A screen may be considered stable if changes over time of the screen are deemed insignificant. A screen may be considered stable if it is determined that changes over time of the screen may be ignored. The terms “snapshot” and “screenshot” as used herein generally refer to any graphical information (e.g., a set of pixels) usable to adequately represent or reproduce a screen as displayed or presented by an application. The terms “snapshot” and “screenshot” may be used interchangeably herein.

A method of automatically determining a screen is stable may include capturing a first snapshot of a screen (e.g., by CU 320) and designating the first snapshot as a candidate or potential representation of the screen. Otherwise described, a candidate or potential snapshot may be regarded as the currently most suitable snapshot for representing a screen presented by an application. For example, provided with a snapshot, MSMU 325 may designate the snapshot as the candidate snapshot. A candidate snapshot may be stored and/or represented as shown by 210 in FIG. 2 and respectively described herein. Regions including elements in the candidate snapshot may be defined as described herein.

A method may include repeatedly capturing snapshots of a screen and relating them to the candidate snapshot. At any point or step of the method, if it is determined that the candidate snapshot matches a snapshot already acquired (e.g., already stored in a model such as model 330), or is otherwise suitable for representing the relevant screen, the method may terminate. Termination of the process, flow or method may include determining a screen is stable. At any point or step of the method, if it is determined that the candidate snapshot was provided as a snapshot representing the screen, then the method or flow may terminate. For example, CU 320 may perform a method of automatically determining a screen presented by an application is stable and may terminate the method upon determining that a candidate snapshot was provided to MSMU 325. Generally, the method includes relating or comparing a candidate snapshot to other snapshots of a screen. For example, comparing a candidate snapshot to subsequently acquired snapshots may include defining regions in the snapshots, generating a digital difference image (diff-image), defining diff-regions in the diff-image and determining a match between a candidate snapshot and another snapshot using any one of the methods described herein.

A method may include repeatedly capturing snapshots of a screen and comparing (or otherwise relating) them to a candidate snapshot. For example, after designating a snapshot as a candidate snapshot, a subsequently captured snapshot of the screen may be related or compared to the candidate snapshot. At an initial phase or upon other conditions, a match counter may be set to zero (“0”) or otherwise reset, similarly, a mismatch counter may be set to a predefined value. At an initial phase or upon other conditions, a stability counter may be set to a predefined value (e.g., zero). Similarly, an instability counter may be reset.

For each new, or subsequently captured snapshot of the screen, if it is determined the new snapshot matches the candidate snapshot, the stability counter may be raised by a predefined value (e.g., one “1”). If the stability counter reaches or exceeds a predefined value, a system (e.g., system 300) may determine the screen is stable. Upon or after determining a screen is stable, the current candidate snapshot may be provided, and possibly stored, as a representation of the screen.

For example, a threshold of five (“5”) may be set for a stability counter and, if the value of the stability counter reaches or exceeds the value of five (“5”), e.g., after determining five snapshots match the candidate snapshot, the candidate snapshot may be provided and stored as a snapshot that represents the screen. For example, the candidate snapshot may be stored as shown by representation 210 in FIG. 2. Any information, parameter or data may be stored in association with, or in relation to, a provided candidate snapshot, e.g., information as included in representation 210. Accordingly, a model may be generated or updated by a system, or a session may be recorded by determining a screen is stable and including a snapshot of the stable screen in a model or in a recorded session.

A match between a new snapshot and a candidate snapshot may be determined by examining any information related to the new and candidate snapshots. For example, bitmaps or any other data (e.g., as described with respect to representations 210 and 215) may be examined, compared or related. Accordingly, a mismatch between a new snapshot and a candidate snapshot may be determined. Accordingly, any graphical or appearance difference (e.g., related to color, size, shape etc.) between a new and candidate snapshots may be identified.

If a mismatch between a new snapshot and candidate snapshot is identified, a method may include determining regions that include, contain or cover areas of the snapshots where differences or mismatches are present (also referred to herein as diff-regions), e.g., as shown by 835 in FIG. 8. One or more diff-regions related to a mismatch between a snapshot and a candidate snapshot may be associated with a method or flow and/or with a snapshot or screen of an application. Regions related to differences may be stored and may be dynamically updated or modified, e.g., diff-regions related to a screen may be updated a number of times during a method described herein.

If a mismatch between a candidate snapshot and a new snapshot is identified, the candidate snapshot may be replaced by the new snapshot, effectively designating the new snapshot as the candidate snapshot. An associated stability counter may be reset if a mismatch between a candidate snapshot and a new snapshot is identified. If a mismatch between a candidate snapshot and a new snapshot is identified, an associated volatility mask may be updated or modified according to diff-regions identified and stored, e.g., in a previous step or time as described herein. For example, an associated volatility mask may be modified such that identified or determined diff-regions in the new snapshot (that replaces the previous candidate snapshot) are included in the volatility mask. For example, by including diff-regions in a volatility mask, areas where differences were identified may be designated as volatile areas, e.g., areas where changes are expected and may be ignored.

When a mismatch is determined, an associated instability counter may be increased, e.g., a value of an associated instability counter may be increased by one each time a mismatch is determined. At any point during a process or during performing the flow or method, if the associated instability counter reaches a predefined value, the associated instability counter may be reset. When the value of an associated instability counter reaches a predefined value, the associated volatility mask may be examined. If a predefined criteria related to the volatility mask is met, the volatility mask may be reset. For example, if more than a predefined portion of a screen is included in the associated volatility mask, the volatility mask may be reset to an initial setting. When the value of an associated instability counter reaches a predefined value an unstable snapshot may be provided together with the associated volatility mask, unless the volatility mask was reset as described herein.

Accordingly, a system may store an unstable snapshot and an associated volatility mask that indicates volatile areas in the unstable snapshot. Upon providing either a stable or unstable snapshot, any parameter, counter, region or mask may be reset. Accordingly and as described herein, a method may automatically determine if a screen presented by an application is stable. A snapshot of a stable screen may be recorded. As further described, a volatility mask identifying volatile or dynamic regions in a screen may be updated or modified based on diff-regions. For example and as described, a volatility mask may be updated based on, or to include, regions where differences between a new and candidate snapshot are identified (e.g., diff-regions as referred to herein). Based on a volatility mask, regions in a new snapshot and a candidate snapshot may be ignored or otherwise treated. For example, when comparing a first and second snapshots (e.g., of a new snapshot and a candidate snapshot previously acquired or generated), volatile regions may be ignored. For example, a region where dynamic content is presented (e.g., regions where different values are displayed, banners and the like) may be ignored when comparing snapshots of screens.

Methods and flows described herein may be performed or executed by a dedicated device. For example, executable code 425 in device 400 described herein may carry out methods such as a method of automatically identifying a region of interest in an image of a screen or a method of automatically matching images of screens as described herein.

Methods of comparing or otherwise related digital images are known, for example, comparing pixels data in images. In contrast to comparing data at pixel level, embodiments of the invention compare or relate images at region level as described herein. A method utilizing regions, diff-images and diff-regions as described herein has a number of advantages that are impossible to realize using known techniques. For example, using diff-images and diff-regions as described herein to relate images is far faster than pixel oriented processing.

Known methods typically determine a match or mismatch based on any difference, e.g., in an intensity of a pixel. In contrast, using diff-images and diff-regions as described herein enables matching images that would be considered same or similar by a human but different by a known computerized method. For example, presented with two screens that are the same other than a user name in a text box, a human may perceive or view the two screens as same or similar but a computerized method would conclude the two screens are differ. By eliminating regions or diff-regions based on a rule as described herein, an embodiment may be configured to identify a match between images the same way a human would. For example and as described, using volatile regions, marker regions, floating regions and other regions as described herein, a computerized method may closely mimic a human when determining a match between images. A method using a region, a diff-image and diff-regions as described herein may be used in adding screenshots to a model or recorded session. For example and as described, updating a model or recorded session includes matching images. Matching images as part of generating or updating a model or recorded session may be done according to a method of automatically identifying a region of interest in an image of a screen and/or a method of automatically matching images of screens as described herein.

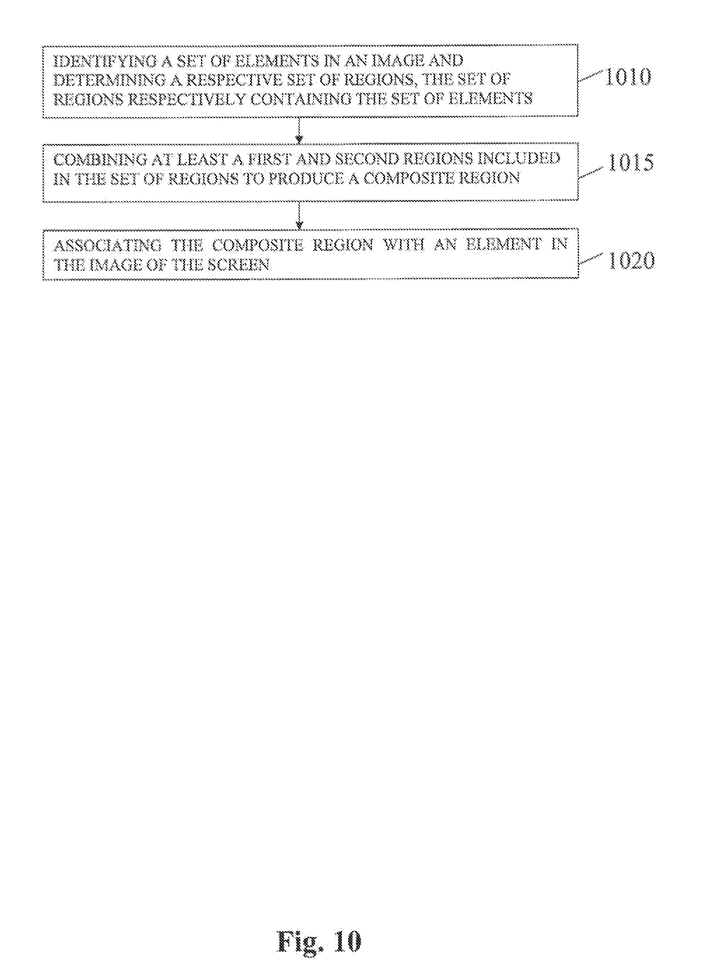

Reference is made to FIG. 10, a flowchart diagram illustrating a method according to some embodiments of the present invention. As shown by block 1010, a method or flow may include identifying a set of elements in an image and determining a respective set of regions, each region in the set of regions respectively including containing one of the set of elements. For example, regions 641 and 642 may be determined by identifying elements 615 and 626 respectively. As shown by FIG. 6, regions are identified or defined such that they contain identified elements. For example, region 642 contains text elements (e.g., characters) as shown by 626.

As shown by block 1015, an embodiment of a method or flow may include combining at least a first and second regions included in the set of regions to produce a composite region. For example, a set of characters (e.g., a text string) displayed on a screen may be associated with a single composite region. For example, as described (and shown FIG. 6B), rectangles 651 in image 650 may be joined into a single composite region 661.

As shown by block 1020, an embodiment of a method or flow may include associating or linking a composite region with an element in the image of the screen. As described herein, a region associated or linked to with an element may be determined to be a region of interest. Accordingly, regions of interest may be defined or identified based on elements they include or are associated with as described.

For example, composite region 671 shown in FIG. 6B is associated with elements in the text input box shown in image 110 in FIG. 2. Accordingly, actual regions of interest related to elements in an original screen may be identified and/or defined. As shown and described, a composite region may be used to identify the elements it contains.

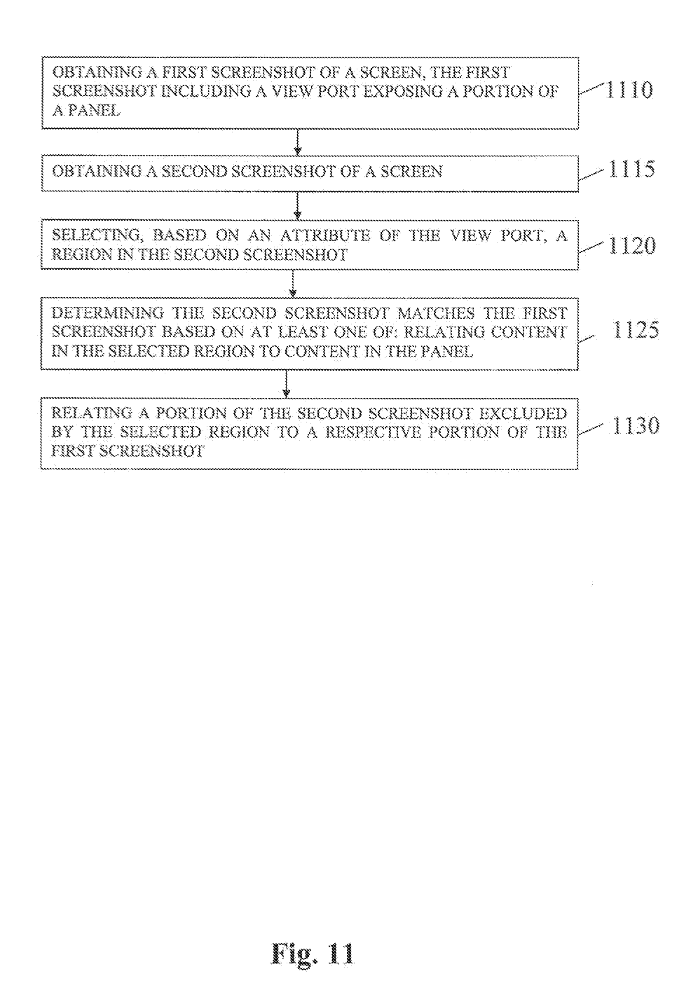

Reference is made to FIG. 11, a flowchart illustrating a method according to some embodiments of the present invention. As shown by block 1110, an embodiment of a method or flow may include obtaining a first screenshot or still image of a display or screen, for example displayed on a computer monitor or smartphone screen, the first screenshot including a view port exposing a portion of a panel. For example and as described, a screenshot obtained may be a screenshot 710 that includes a viewport 720 where viewport 720 exposes a portion of panel 730. For example and as known in the art, a webpage or other content displayed on a screen may include a portion that revels only part of an underlying image or other content. As known in the art, a viewport may include scroll bars that enable to change the content in the viewport, e.g., navigating through the underlying content. For example, only a portion of an image in an underlying image may be shown in a viewport and other portions of the image may be seen by scrolling the viewport up, down or sideways.

As shown by block 1115, an embodiment of a method or flow may include obtaining a second screenshot or image of a screen. The same system or method for obtaining the first screenshot may be used to obtain the second screenshot.

As shown by block 1120, an embodiment of a method or flow may include selecting, based on an attribute of the view port, a region in the second screenshot. For example, the first screenshot may be screenshot 710, the second screenshot may be screenshot 740 and the selected region in the second screenshot may be region 745. Screenshots 710 and 740 and region 745 are further discussed with reference to FIG. 7. An attribute of a view port may be, for example, the size of the view port, the location of the view port in a screenshot or a graphical element exposed by the view port.

As shown by block 1125, an embodiment of a method or flow may include determining the second screenshot matches the first screenshot based on at least one of: relating content in the selected region to content in the panel. For example, an embodiment of a method may determine screenshots 710 and 740 match based on relating content in region 745 to content in panel 730, e.g., comparing content in region 745 with content in panel 730.

As shown by block 1130, an embodiment of a method or flow may include relating a portion of the second screenshot excluded by the selected region to a respective portion of the first screenshot. For example, region 745 may be excluded from (or ignored in), a process of comparing or relating screenshots 710 and 740.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention. Various embodiments have been presented. Each of these embodiments may of course include features from other embodiments presented, and embodiments not specifically described may include various features described herein. Unless explicitly stated, the method embodiments described herein are not constrained to a particular order or sequence. Additionally, some of the described method embodiments or elements thereof can occur or be performed at the same point in time. Some of the described method embodiments or elements thereof can include, where applicable, elements or operations that are described herein but not specifically described as included in the described method embodiments.

What is claimed is:

1. A computer-implemented method of automatically matching images of screens, the method comprising:
obtaining a first screenshot of a screen, the first screenshot including a view port exposing a portion of a panel;
obtaining a second screenshot of a screen;
selecting, based on an attribute of the view port, a region in the second screenshot;
determining the second screenshot matches the first screenshot based on at least one of: relating content in the selected region to content in the panel, and
relating a portion of the second screenshot excluded by the selected region to a respective portion of the first screenshot.

2. The method of claim 1, wherein an attribute of the view port is at least one of: a size of the view port, a location of the view port and a graphical element exposed by the view port.

3. The method of claim 1, comprising:
identifying a graphical element in the panel, the element exposed by the view port; and
selecting the region in the second screenshot such that it includes the element.

4. The method of claim 1, comprising:
generating a digital difference image representing at least one difference between one of: the second screenshot and the first screenshot and the second screenshot and the panel;
defining a sub-region in the digital difference image, the sub-region excluding a border region in the digital difference image; and
determining the second screenshot matches the first screenshot based on the sub-region.

5. The method of claim 1, comprising:
generating a digital difference image representing at least one difference between one of: the second screenshot and the first screenshot and the second screenshot and the panel;
producing a processed digital difference image by removing elements smaller then a threshold size from the digital difference image; and
determining the second screenshot matches the first screenshot based on the processed digital difference image.

6. The method of claim 1, comprising:
generating a digital difference image representing at least one difference between one of: the second screenshot and the first screenshot and the second screenshot and the panel;
determining a sub-region in the digital difference image matches identified respective regions in at least one of: the second screenshot and the first screenshot and the second screenshot and the panel, wherein the respective regions correspond to a graphical element included in the first screenshot and in the second screenshot;
producing a processed digital difference image by removing a representation of a difference included in the sub-region; and
determining the second screenshot matches the first screenshot based on the processed digital difference image.

7. The method of claim 1, comprising:
generating a digital difference image representing at least one difference between one of: the second screenshot and the first screenshot and the second screenshot and the panel;
determining a sub-region in the digital difference image is contained in a similar respective region in at least one of: the second screenshot and the first screenshot and the second screenshot and the panel;
producing a processed digital difference image by removing a representation of a difference included in the sub-region; and
determining the second screenshot matches the first screenshot based on the processed digital difference image.

8. The method of claim 1, comprising:
generating a digital difference image representing at least one difference between one of: the second screenshot and the first screenshot and the second screenshot and the panel;
determining a sub-region in the digital difference image corresponds to at least one of: a region in the panel marked as floating and a region in the first screenshot marked as floating;
determining a sub-region in the second screenshot that matches a sub-region in the digital difference image also matches one of the regions marked as floating;
producing a processed digital difference image by removing a representation of a difference included in one or more sub-regions in the digital difference image, the one or more sub-regions corresponding to at least one of:
one of the regions marked as floating and to the sub-region in the second screenshot; and
determining the second screenshot matches the first screenshot based on the processed digital difference image.

9. The method of claim 1, comprising:
generating a digital difference image representing at least one difference between one of: the second screenshot and the first screenshot and the second screenshot and the panel;
determining a sub-region in the digital difference image corresponds to at least one of: a region in the panel marked as a marker region and a region in the first screenshot marked as a marker region; and
if no differences are included in the sub-region then determining the second screenshot matches the first screenshot.

10. The method of claim 1, comprising:
generating a digital difference image representing at least one difference between one of: the second screenshot and the first screenshot and the second screenshot and the panel;
determining a sub-region in the digital difference image corresponds to at least one of: a region in the panel marked as a volatile region and a region in the first screenshot marked as a volatile region;
producing a processed digital difference image by removing a representation of a difference included in the sub-region; and
determining the second screenshot matches the first screenshot based on the processed digital difference image.

11. The method of claim 1, wherein at least one of the first and second screenshots is one of:
a screenshot of a screen produced by an application and a manually generated digital image of a screen.

12. The method of claim 1, comprising:
generating a digital difference image representing at least one difference between one of: the second screenshot and the first screenshot and the second screenshot and the panel; and
determining the second screenshot matches the first screenshot if:
a set of representations of differences between the first screenshot and the second screenshot is confined by a confining a region in the digital difference image, and
the confining region is smaller than a threshold value.

13. The method of claim 1, comprising:
generating a digital difference image representing at least one difference between one of: the second screenshot and the first screenshot and the second screenshot and the panel; and
determining the second screenshot matches the first screenshot if the number of pixels representing a difference in the diff image is smaller than a threshold value.

14. The method of claim 1, comprising:
generating a digital difference image representing at least one difference between one of: the second screenshot and the first screenshot and the second screenshot and the panel;
determining the second screenshot matches the first screenshot if:
a sub-region in the digital difference image matches an identified region in only one of: the second screenshot and one of the first screenshot and the panel,
one or more identified regions in another one of: the second screenshot and one of the first screenshot and the panel are included in an area defined by the sub-region, and
the one or more identified regions are respectively present in the only one of: the second screenshot and one of the first screenshot and the panel.

15. An article comprising a non-transitory computer-readable storage medium, having stored thereon instructions, that when executed by a processor, cause the processor to:
obtain a first screenshot of a screen, the first screenshot including a view port exposing a portion of a panel;
obtain a second screenshot of a screen;
select, based on an attribute of the view port, a region in the second screenshot;
determine the second screenshot matches the first screenshot based on at least one of: relating content in the selected region to content in the panel, and
relating a portion of the second screenshot excluded by the selected region to a respective portion of the first screenshot.

16. The article of claim 15, wherein an attribute of the view port is at least one of: a size of the view port, a location of the view port and a graphical element exposed by the view port.

17. The article of claim 15, wherein the instructions when executed further result in:
identifying a graphical element in the panel, the element exposed by the view port; and
selecting the region in the second screenshot such that it includes the element.

18. The article of claim 15, wherein the instructions when executed further result in:
generating a digital difference image representing at least one difference between one of: the second screenshot and the first screenshot and the second screenshot and the panel;
defining a sub-region in the digital difference image, the sub-region excluding a border region in the digital difference image; and
determining the second screenshot matches the first screenshot based on the sub-region.

19. The article of claim 15, wherein the instructions when executed further result in:
generating a digital difference image representing at least one difference between one of: the second screenshot and the first screenshot and the second screenshot and the panel;
producing a processed digital difference image by removing elements smaller then a threshold size from the digital difference image; and
determining the second screenshot matches the first screenshot based on the processed digital difference image.

20. The article of claim 15, wherein the instructions when executed further result in:
generating a digital difference image representing at least one difference between one of: the second screenshot and the first screenshot and the second screenshot and the panel;
determining a sub-region in the digital difference image matches identified respective regions in at least one of: the second screenshot and the first screenshot and the second screenshot and the panel, wherein the respective regions correspond to a graphical element included in the first screenshot and in the second screenshot;
producing a processed digital difference image by removing a representation of a difference included in the sub-region; and
determining the second screenshot matches the first screenshot based on the processed digital difference image.
